(19) United States
(12) Patent Application Publication
(10) Pub. No.: US 2023/0275349 A1
(43) Pub. Date: Aug. 31, 2023

(54) ANTENNA, WIRELESS COMMUNICATION MODULE, PACKAGE RECEIVING APPARATUS, AND PACKAGE RECEIVING SYSTEM

(71) Applicant: KYOCERA CORPORATION, Kyoto-shi, Kyoto (JP)

(72) Inventors: Nobuki HIRAMATSU, Yokohama-shi, Kanagawa (JP); Hikaru NEKOZUKA, Yokohama-shi, Kanagawa (JP); Gen MATSUI, Ota-ku, Tokyo (JP); Kenji TACHIBATAKE, Hirakata-shi, Osaka (JP)

(21) Appl. No.: 18/005,970

(22) PCT Filed: Jul. 13, 2021
(86) PCT No.: PCT/JP2021/026346

§ 371 Date: Jan. 19, 2023

(30) Foreign Application Priority Data
Jul. 27, 2020 (JP) 2020-126196

(51) Int. Cl. H01Q 5/357; H01Q 1/12; H01Q 1/42

(52) U.S. Cl. CPC H01Q 5/357; H01Q 1/12; H01Q 1/42

(57) ABSTRACT

An antenna according to an aspect includes an antenna body configured to radiate an electromagnetic wave when entering a first mode exhibiting an artificial magnetic conductor character with respect to an electromagnetic wave in a first frequency band and entering a second mode serving as a resonator for the electromagnetic wave in a second frequency band higher than the first frequency band and a package receiving box (case) configured to support the antenna body and to be placed on a placement surface directly or via a placement member. The antenna body is supported by the package receiving box with a direction of an electrical current in the first mode being parallel to the placement surface.

### RELATED APPLICATIONS

The present application is a National Phase of International Application Number PCT/JP2021/026346 filed Jul. 13, 2021, which claims the benefit of priority from Japanese Patent Application No. 2020-126196, filed on Jul. 27, 2020.

### TECHNICAL FIELD

The present disclosure relates to an antenna, a wireless communication module, a package receiving apparatus, and a package receiving system.

### BACKGROUND OF INVENTION

An example of a known antenna is a dipole antenna (see, for example, PTL 1). The dipole antenna of PTL 1 includes a radiation element and a reflective element disposed in parallel to each other inside a magnetic material. The radiation element and the reflective element have a folded dipole structure including a dipole element whose both ends are folded.

### CITATION LIST

### Patent Literature

PLT 1: JP 2012-105189 A

### SUMMARY

### Problem to Be Solved

The dipole antenna when installed on metal may have a reduced input impedance or a narrower frequency band, degrading the antenna characteristics.

An object of the present disclosure is to provide an antenna that can be placed preventing decrease in antenna characteristics, a wireless communication module, a package receiving apparatus, and a package receiving system.

### Solution to Problem

An antenna according to an aspect includes an antenna body configured to radiate an electromagnetic wave when entering a first mode exhibiting an artificial magnetic conductor character with respect to an electromagnetic wave in a first frequency band and entering a second mode to function as a resonator for the electromagnetic wave in a second frequency band higher than the first frequency band and a case configured to support the antenna body and to be placed on a placement surface directly or via a placement member. The antenna body is supported by the case with a direction of an electrical current in the first mode being parallel to the placement surface.

An antenna according to an aspect includes an antenna body including a first conductor, a second conductor facing the first conductor in a first direction, a plurality of third conductors positioned between the first conductor and the second conductor and extending along the first direction, a fourth conductor connected to the first conductor and the second conductor and extending along the first direction, and a feed line electromagnetically connected to the third conductor and a case configured to support the antenna body and to be placed on a placement surface. The antenna body is supported by the case with the first direction being parallel to the placement surface.

A wireless communication module according to an aspect includes the antenna described above and an RF module housed in the housing case and electrically connected to the antenna body.

A package receiving apparatus according to an aspect includes the wireless communication module described above, a package receiving box provided with the wireless communication module and configured to house a package, and a controller electrically connected to the wireless communication module and configured to manage the package housed in the package receiving box. The case is the package receiving box.

A package receiving system according to an aspect includes the package receiving apparatus described above and a communication apparatus configured to receive package information wirelessly transmitted from the package receiving apparatus.

### BRIEF DESCRIPTION OF THE DRAWINGS

FIG. 1 is a perspective view of a package receiving apparatus according to an embodiment.

FIG. 2 is a front view illustrating part of the package receiving apparatus.

FIG. 3 is a perspective view of an antenna according to the embodiment.

FIG. 4 is an exploded perspective view of an antenna according to an embodiment.

FIG. 5 is a perspective view of an antenna body according to an embodiment.

FIG. 6 is an exploded perspective view of part of the antenna body illustrated in FIG. 5.

FIG. 7 is a cross-sectional view of the antenna body illustrated in FIG. 5 taken along line A-A.

FIG. 8 is a plan view schematically illustrating electrical currents and an electrical field when an electromagnetic wave in a first frequency band is radiated.

FIG. 9 is a cross-sectional view of the state illustrated in FIG. 8.

FIG. 10 is a plan view schematically illustrating electrical currents and an electrical field when an electromagnetic wave in a second frequency band is radiated.

FIG. 11 is a cross-sectional view of the state illustrated in FIG. 10.

FIG. 12 is a plan view schematically illustrating electrical currents and an electrical field when an electromagnetic wave in a third frequency band is radiated.

FIG. 13 is a cross-sectional view of the state illustrated in FIG. 12.

FIG. 14 is a diagram illustrating input impedance of the antenna.

FIG. 15 is a graph showing an example of reflection characteristics with respect to a frequency of the antenna.

FIG. 16 is a graph showing an example of reflection characteristics with respect to a frequency of the antenna.

FIG. 17 is a diagram illustrating a package receiving system including a package receiving apparatus according to an embodiment.

FIG. 18A is a front view illustrating an example of an arrangement of the antenna in a package receiving apparatus according to an embodiment.

FIG. 18B is a top view illustrating the example of the arrangement of the antenna in the package receiving apparatus according to the embodiment.

FIG. 18C is a side view illustrating the example of the arrangement of the antenna in the package receiving apparatus according to the embodiment.

FIG. 19 is a schematic view illustrating an example of relationship between the antenna according to the embodiment and a placement surface.

FIG. 20 is a diagram illustrating an example of a radiation pattern in a radiation plane of the antenna illustrated in FIG. 19.

FIG. 21A is a front view illustrating an example of a package receiving apparatus according to Reference Example (1).

FIG. 21B is a top view illustrating the example of the package receiving apparatus according to Reference Example (1).

FIG. 21C is a side view illustrating the example of the package receiving apparatus according to Reference Example (1).

FIG. 22 is a diagram illustrating an example of a radiation pattern of a dipole antenna according to Reference Example (1) illustrated in FIG. 21.

FIG. 23A is a front view illustrating an example of an arrangement of the antenna in a package receiving apparatus according to Reference Example (2).

FIG. 23B is a top view illustrating the example of the arrangement of the antenna in the package receiving apparatus according to Reference Example (2).

FIG. 23C is a side view illustrating the example of the arrangement of the antenna in the package receiving apparatus according to Reference Example (2).

FIG. 24 is a diagram illustrating an example of a radiation pattern in a radiation plane of the antenna according to Reference Example (2) illustrated in FIG. 23.

FIG. 25A is a front view illustrating an example of an arrangement of an antenna in a package receiving apparatus according to Reference Example (3).

FIG. 25B is a top view illustrating the example of the arrangement of the antenna in the package receiving apparatus according to Reference Example (3).

FIG. 25C is a side view illustrating the example of the arrangement of the antenna in the package receiving apparatus according to Reference Example (3).

FIG. 26 is a diagram illustrating an example of a radiation pattern of the antenna according to Reference Example (3) illustrated in FIG. 25.

FIG. 27 is a front view illustrating another example of placement of a package receiving apparatus according to an embodiment.

FIG. 28 is a front view illustrating another example of placement of a package receiving apparatus according to an embodiment.

FIG. 29 is a diagram illustrating another example of an antenna body according to the embodiment.

FIG. 30A is a cross-sectional view taken along line LVIa-LVIa illustrated in FIG. 29.

FIG. 30B is a cross-sectional view taken along line LVIb-LVIb illustrated in FIG. 29.

FIG. 31 is a front view illustrating another example of an arrangement of an antenna in a package receiving apparatus according to an embodiment.

FIG. 32 is a diagram illustrating another example of an antenna body illustrated in FIG. 29.

### DESCRIPTION OF EMBODIMENTS

A detailed description of an embodiment according to the present disclosure will be given with reference to the drawings. In the following description, similar constituent elements may be assigned the same reference signs. Furthermore, redundant descriptions may be omitted. In addition, matters that are not closely related to the description of the embodiment according to the present disclosure may be omitted from the description and illustrations. Note that the present disclosure is not limited by the following embodiment. Further, the following embodiment includes elements that can be easily conceived by those skilled in the art, elements that are substantially the same, and elements in a so-called equivalent range.

### Embodiment

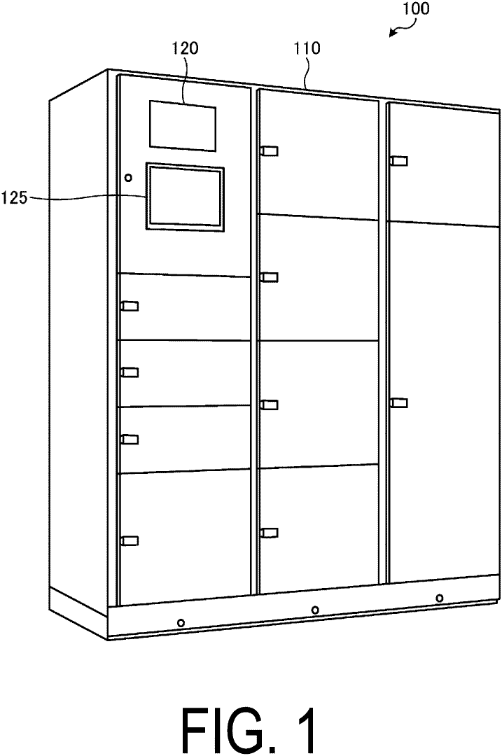

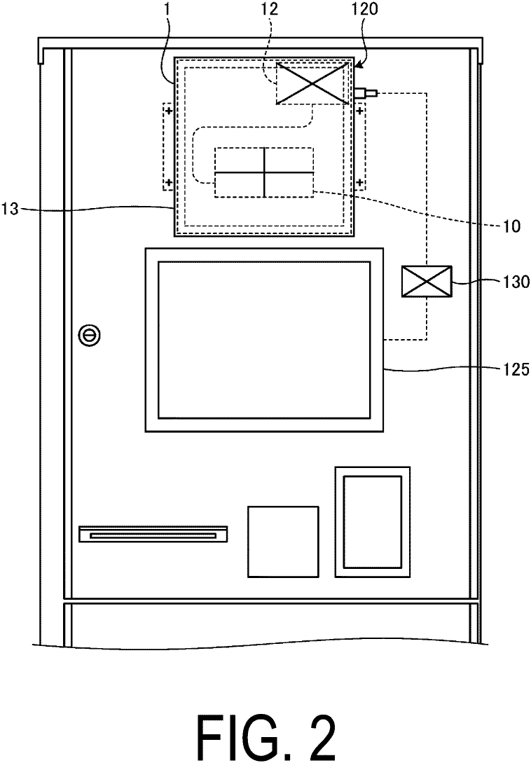

FIG. 1 is a perspective view of a package receiving apparatus according to an embodiment. FIG. 2 is a front view illustrating part of the package receiving apparatus. A package receiving apparatus 100 is a system that receives and stores a package that is delivered by a deliverer and is to be received by a receiver. Examples of the package include mail and delivered articles. The package receiving apparatus 100 is, for example, a delivery locker having storage and management functions.

As illustrated in FIG. 1 and FIG. 2, the package receiving apparatus 100 includes a package receiving box 110, a wireless communication module 120, a display 125, and a controller 130. The package receiving box 110 is formed by a conductor or the like to have a rectangular outer shape. The package receiving box 110 includes a plurality of storages for storing packages. Each storage of the package receiving box 110 is accessed from a front side thereof by a deliverer to store a package. Further, each storage of the package receiving box 110 is accessed from, for example, the front side thereof by a receiver to pick up the package. The wireless communication module 120 can bidirectionally and wirelessly communicate with outside. The display 125 is provided in the front side of the package receiving box 110. The display 125 is, for example, a display device such as a liquid crystal display.

The controller 130 comprehensively controls the operation of the package receiving apparatus 100 to implement various functions. The controller 130 includes an integrated circuit such as a central processing unit (CPU). The controller 130 is electrically connected to the wireless communication module 120. The controller 130 wirelessly communicates with the outside via the wireless communication module 120. Specifically, the controller 130 controls to manage the package stored in the package receiving box 110. The controller 130 communicates with the outside via the wireless communication module 120 to exchange information for managing the package. The controller 130 controls the display 125 to display a screen that provides the information for managing the package.

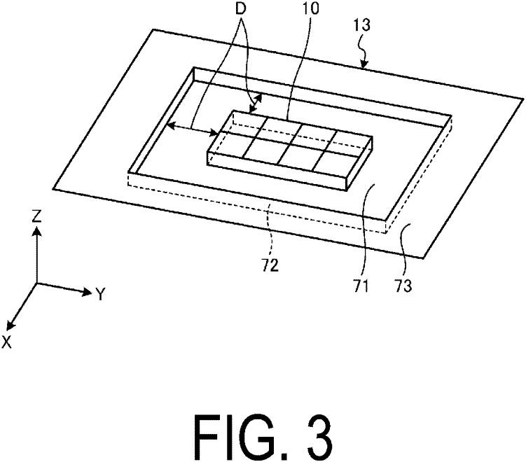

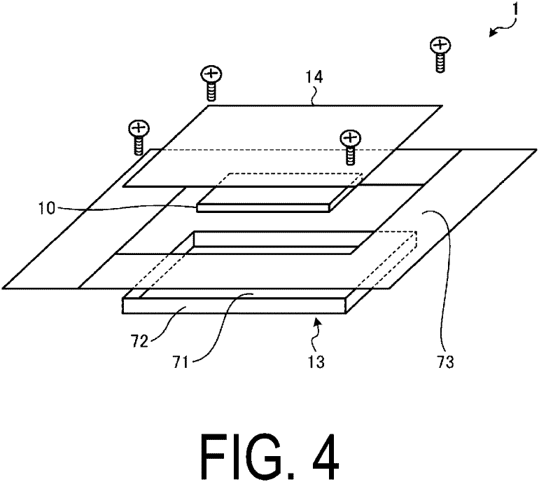

Next, the wireless communication module 120 will be described with reference to FIG. 1 to FIG. 4. FIG. 3 is a perspective view of an antenna according to the embodiment. FIG. 4 is an exploded perspective view of the antenna according to the embodiment. The wireless communication module 120 is provided in the front of the package receiving box 110. The wireless communication module 120 includes an antenna 1 and an RF module 12. The antenna 1 includes an antenna body 10, a housing case 13, and a cover 14. The RF module 12 is housed in the housing case 13 and is electrically connected to the antenna body 10.

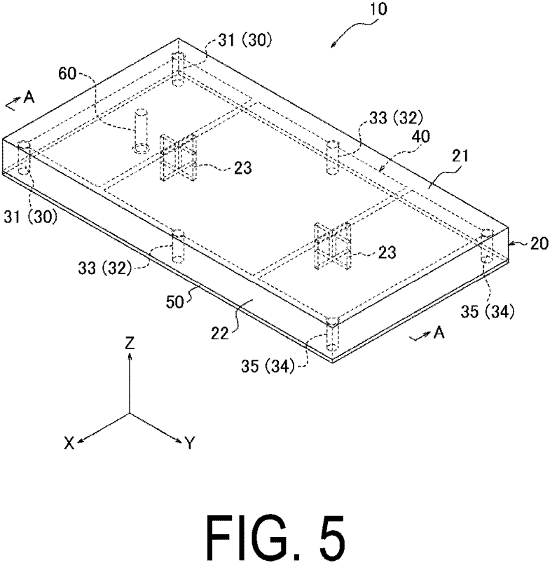

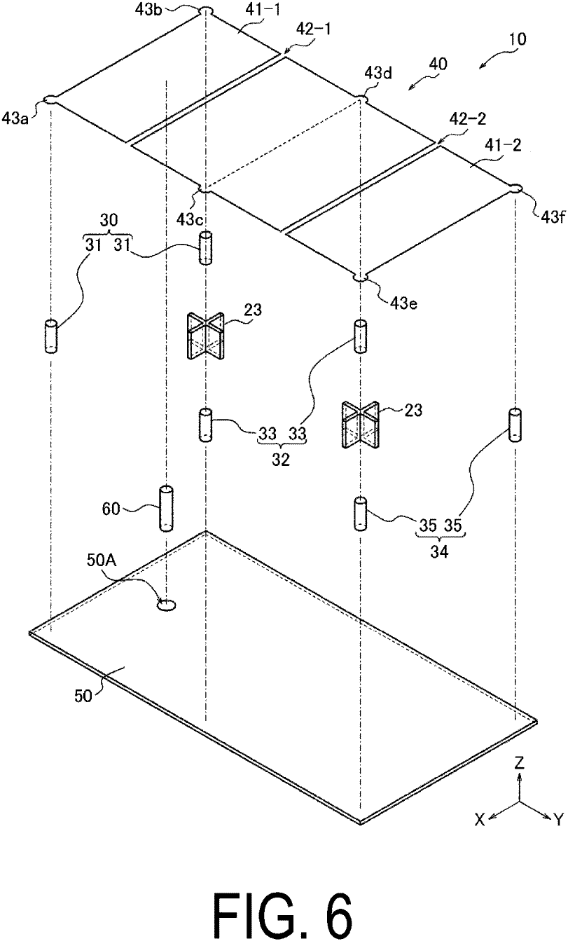

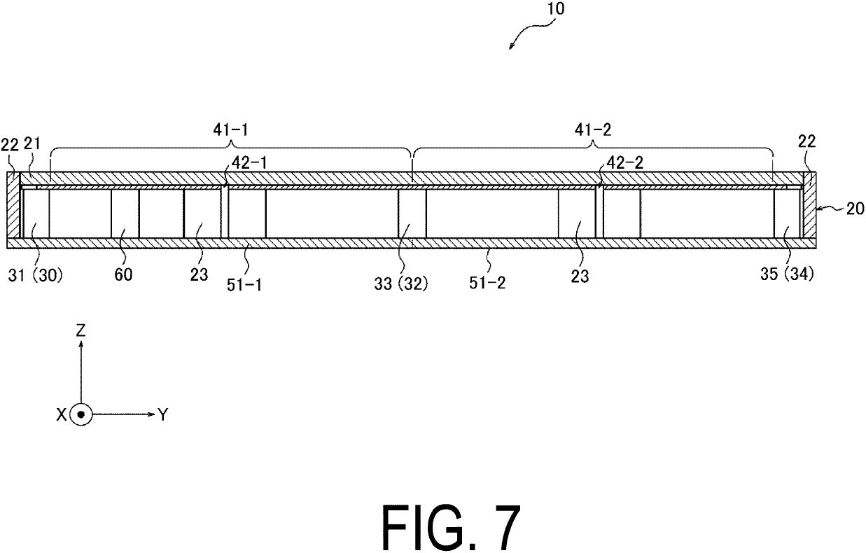

The antenna body 10 will be described with reference to FIG. 5 to FIG. 13. FIG. 5 is a perspective view of the antenna body according to the embodiment. FIG. 6 is a partially exploded perspective view of the antenna body illustrated in FIG. 5. FIG. 7 is a cross-sectional view of the antenna body illustrated in FIG. 5 taken along line A-A.

The following description employs an XYZ coordinate system. Hereinafter, in a case where an X axis positive direction and an X axis negative direction are not particularly distinguished, the X axis positive direction and the X axis negative direction are collectively referred to as an “X direction.” In a case where a Y axis positive direction and a Y axis negative direction are not particularly distinguished, the Y axis positive direction and the Y axis negative direction are collectively referred to as a “Y direction.” In a case where a Z axis positive direction and a Z axis negative direction are not particularly distinguished, the Z axis positive direction and the Z axis negative direction are collectively referred to as a “Z direction.”

As illustrated in FIG. 5 and FIG. 6, the antenna body 10 includes a base 20, a first connection conductor group 30, a second connection conductor group 32, a third connection conductor group 34, a first conductor 40, a second conductor 50, and a feed line 60. The first connection conductor group 30, the second connection conductor group 32, the third connection conductor group 34, the first conductor 40, the second conductor 50, and the feed line 60 may include the same conductive material or different conductive materials.

The “conductive material” in the present disclosure may include any of a metal material, an alloy of metal materials, a cured material of metal paste, and a conductive polymer as composition. Examples of the metal material include copper, silver, palladium, gold, platinum, aluminum, chrome, nickel, cadmium lead, selenium, manganese, tin, vanadium, lithium, cobalt, and titanium. The alloy includes a plurality of metal materials. The metal paste includes a powder of a metal material kneaded with an organic solvent and a binder. Examples of the binder include an epoxy resin, a polyester resin, a polyimide resin, a polyamide-imide resin, and a polyetherimide resin. Examples of the conductive polymer include a polythiophene polymer, a polyacetylene polymer, a polyaniline polymer, and a polypyrrole polymer.

The antenna body 10 may exhibit an artificial magnetic conductor character with respect to the electromagnetic wave in a predetermined frequency that is incident on a plane where the first conductor 40 is located from the outside.

In the present disclosure, the “artificial magnetic conductor character” means a characteristic of a plane where a phase difference between an incident wave and a reflected wave at one resonant frequency is 0 degrees. The antenna body 10 can have an operating frequency in the vicinity of at least one of at least one resonant frequency. On the plane having the artificial magnetic conductor character, the phase difference between the incident wave and the reflected wave at the operating frequency band is smaller than a range from -90 degrees to +90 degrees.

The base 20 is configured to support the first conductor 40. The outer appearance shape of the base 20 may be substantially rectangular in accordance with the shape of the first conductor 40. The base 20 may include a dielectric material. The relative permittivity of the base 20 may be adjusted as appropriate in accordance with the desired resonant frequency of the antenna body 10.

In the present disclosure, the “dielectric material” may include either a ceramic material or a resin material as composition. Examples of the ceramic material include an aluminum oxide sintered body, an aluminum nitride sintered body, a mullite-based sintered body, a glass ceramic sintered body, crystallized glass yielded by precipitation of a crystal component in a glass base material, and a microcrystalline sintered body such as mica or aluminum titanate. Examples of the resin material include an epoxy resin, a polyester resin, a polyimide resin, a polyamide-imide resin, a polyetherimide resin, and resin materials yielded by curing an uncured liquid crystal polymer or the like.

As illustrated in FIG. 7, the base 20 includes an upper portion 21, a side wall portion 22, and two pillar portions 23. However, the base 20 may have one or three or more of pillar portions 23 in accordance with, for example, the size of the antenna body 10. The base 20 may not have the pillar portions 23 in accordance with, for example, the size of the antenna body 10.

The upper portion 21 extends along an XY plane. The upper portion 21 may have a substantially rectangular shape in accordance with the shape of the first conductor 40. However, the upper portion 21 may have any shape in accordance with the shape of the first conductor 40. The upper portion 21 includes two surfaces substantially parallel to the XY plane. One of the two surfaces included in the upper portion 21 faces an outer side of the base 20. The other of the two surfaces faces an inner side of the base 20.

The side wall portion 22 surrounds an outer peripheral portion of the upper portion 21 having the substantially rectangular shape. The side wall portion 22 is connected to the outer peripheral portion of the upper portion 21. The side wall portion 22 extends from the outer peripheral portion of the upper portion 21 toward the second conductor 50 along a Z direction. The region surrounded by the upper portion 21 and the side wall portion 22 is hollow. However, at least a portion of the region surrounded by the upper portion 21 and the side wall portion 22 may be filled with a dielectric material or the like.

The pillar portion 23 is located in the region surrounded by the upper portion 21 and the side wall portion 22. The pillar portion 23 is located between the first conductor 40 and the second conductor 50. The pillar portion 23 is configured to hold a distance between the first conductor 40 and the second conductor 50. The two pillar portions 23 may be configured to hold the distance between the first conductor 40 and the second conductor 50 at different positions from each other. The pillar portion 23 may have a cross shape when viewed from the Z direction.

As illustrated in FIG. 6, the first connection conductor group 30 includes a plurality of first connection conductors 31. In the configuration illustrated in FIG. 6, the first connection conductor group 30 includes two first connection conductors 31. However, the first connection conductor group 30 may include any number of the first connection conductors 31 in accordance with, for example, the shape of the first conductor 40.

The plurality of first connection conductors 31 is aligned in the X direction. When the first connection conductor group 30 includes three or more of the first connection conductors 31, distances between the plurality of first connection conductors 31 aligned in the X direction may be substantially equal. The first connection conductor 31 may be disposed along the Z direction. The first connection conductor 31 may be a conductor having a columnar shape. The first connection conductor 31 may be configured such that one end of the first connection conductor 31 is electrically connected to the first conductor 40 and that the other end of the first connection conductor 31 is electrically connected to the second conductor 50.

The second connection conductor group 32 is aligned with the first connection conductor group 30 in the Y direction. The second connection conductor group 32 includes a plurality of second connection conductors 33. In the configuration illustrated in FIG. 6, the second connection conductor group 32 includes two second connection conductors 33. However, the second connection conductor group 32 may include any number of the second connection conductors 33 in accordance with, for example, the shape of the first conductor 40.

The plurality of second connection conductors 33 is aligned in the X direction. The distance between the second connection conductors 33 aligned in the X direction may be substantially equal to the distance between the first connection conductors 31 aligned in the X direction. The second connection conductor 33 may be disposed along the Z direction. The second connection conductor 33 may be a conductor having a columnar shape. The second connection conductor 33 may be configured such that one end of the second connection conductor 33 is electrically connected to the first conductor 40 and that the other end of the second connection conductor 33 is electrically connected to the second conductor 50.

The third connection conductor group 34 is aligned with the first connection conductor group 30 and the second connection conductor group 32 in the Y direction. The third connection conductor group 34 includes a plurality of third connection conductors 35. In the configuration illustrated in FIG. 6, the third connection conductor group 34 includes two third connection conductors 35. However, the third connection conductor group 34 may include any number of the third connection conductors 35 in accordance with, for example, the shape of the first conductor 40.

The plurality of third connection conductors 35 is aligned in the X direction. The distance between the third connection conductors 35 aligned in the X direction may be substantially equal to at least one of the distance between the first connection conductors 31 aligned in the X direction or the distance between the second connection conductors 33 aligned in the X direction. The third connection conductor 35 may be disposed along the Z direction. The third connection conductor 35 may be a conductor having a columnar shape. The third connection conductor 35 may be configured such that one end of the third connection conductor 35 is electrically connected to the first conductor 40 and that the other end of the third connection conductor 35 is electrically connected to the second conductor 50.

The first conductor 40 is configured to function as a resonator. The first conductor 40 extends along the XY plane. The first conductor 40 is located on the upper portion 21 of the base 20. The first conductor 40 may be located on a surface facing the inner side of the base 20 of the two surfaces that are included in the upper portion 21 and substantially parallel to the XY plane. The first conductor 40 may be a conductor having a flat plate shape. The first conductor 40 may have a substantially rectangular shape. The short side of the first conductor 40 having the substantially rectangular shape is along the X direction. The long side of the first conductor 40 having the substantially rectangular shape is along the Y direction.

The first conductor 40 includes a third conductor 41-1, a third conductor 41-2, and connecting portions 43a, 43b, 43c, 43d, 43e, and 43f. However, the first conductor 40 may not include the connecting portions 43a, 43b, 43c, 43d, 43e, and 43f. Hereinafter, in a case where the third conductor 41-1 and the third conductor 41-2 are not particularly distinguished, these are collectively referred to as the “third conductor 41”. The third conductor 41 and the connecting portions 43a to 43f may include the same conductive material or different conductive materials.

The third conductor 41 may have a substantially rectangular shape. The third conductor 41 includes four corner portions. The third conductor 41 includes two sides along the X direction and two sides along the Y direction. The third conductor 41-1 has a gap 42-1. The third conductor 41-2 has a gap 42-2. Hereinafter, in a case where the gap 42-1 and the gap 42-2 are not particularly distinguished, these are collectively referred to as the “gap 42”. The gap 42 extends from a central portion of one side of the two sides of the third conductor 41 along the Y direction toward a central portion of the other side thereof. The gap 42 extends along the X direction. A portion of the pillar portions 23 on the Z axis positive direction side may be located at a portion at or near the center of the gap 42 extending along the X direction. The width of the gap 42 may be adjusted as appropriate in accordance with the desired operating frequency of the antenna body 10.

The third conductor 41-1 and the third conductor 41-2 are aligned in the Y direction. One side along the X direction on the Y axis positive direction side of the third conductor 41-1 is integrated with one side along the X direction on the Y axis negative direction side of the third conductor 41-2. Two corner portions on the Y axis positive direction side of four corner portions of the third conductor 41-1 are integrated with two corner portions on the Y axis negative direction side of four corner portions of the third conductor 41-2.

The connecting portions 43a and 43b are located at the respective two corner portions of the third conductor 41-1 on the Y axis negative direction side. The connecting portions 43a and 43b are each configured to be electrically connected to the first connection conductor 31. The connecting portions 43a and 43b may have a rounded shape in accordance with the first connection conductor 31. When the first conductor 40 does not include the connecting portions 43a and 43b, the two corner portions of the third conductor 41-1 on the Y axis negative direction side may be configured to be electrically connected directly to the first connection conductor 31.

The connecting portion 43c is located at or near the center of a long side on the X axis positive direction side of two long sides of the first conductor 40. The connecting portion 43c is located, on the X axis positive direction side, at a corner portion on the Y axis positive direction side of the third conductor 41-1 and a corner portion on the Y axis negative direction side of the third conductor 41-2 that are integrated. The connecting portion 43c is configured to be electrically connected to the second connection conductor 33. The connecting portion 43c may have a rounded shape in accordance with the second connection conductor 33. When the first conductor 40 does not include the connecting portion 43c, the corner portion on the Y axis positive direction side of the third conductor 41-1 and the corner portion on the Y axis negative direction side of the third conductor 41-2 that are integrated may be configured to be electrically connected directly to the second connection conductor 33.

The connecting portion 43d is located at or near the center of a long side on the X axis negative direction side of the two long sides of the first conductor 40. The connecting portion 43d is located, on the X axis negative direction side, at the corner portion on the Y axis positive direction side of the third conductor 41-1 and the corner portion on the Y axis negative direction side of the third conductor 41-2 that are integrated. The connecting portion 43d is configured to be electrically connected to the second connection conductor 33. The connecting portion 43d may have a rounded shape in accordance with the second connection conductor 33. When the first conductor 40 does not include the connecting portion 43d, the corner portion on the Y axis positive direction side of the third conductor 41-1 and the corner portion on the Y axis negative direction side of the third conductor 41-2 that are integrated may be configured to be electrically connected directly to the second connection conductor 33.

The connecting portions 43e and 43f are located at the respective two corner portions on the Y axis positive direction side of the third conductor 41-2. The connecting portions 43e and 43f are each configured to be electrically connected to the third connection conductor 35. The connecting portions 43e and 43f may have a rounded shape in accordance with the third connection conductor 35. When the first conductor 40 does not include the connecting portions 43e and 43f, the two corner portions on the Y axis positive direction side of the third conductor 41-2 may be configured to be electrically connected directly to the third connection conductor 35.

The first conductor 40 is configured to capacitively connect the first connection conductor group 30 to the second connection conductor group 32. For example, the third conductor 41-1 is configured to be electrically connected to the respective first connection conductors 31 by the connecting portions 43a and 43b and electrically connected to the respective second connection conductors 33 by the connecting portions 43c and 43d. The first connection conductor 31 and the second connection conductor 33 may be capacitively connected via the gap 42-1 of the third conductor 41-1.

The first conductor 40 is configured to capacitively connect the second connection conductor group 32 to the third connection conductor group 34. For example, the third conductor 41-2 is configured to be electrically connected to the respective second connection conductors 33 by the connecting portions 43c and 43d and electrically connected to the respective third connection conductors 35 by the connecting portions 43e and 43f. The second connection conductor 33 and the third connection conductor 35 may be capacitively connected via the gap 42-2 of the third conductor 41-2.

The first conductor 40 is configured to capacitively connect the first connection conductor group 30 to the third connection conductor group 34. For example, the third conductor 41-1 is configured to be electrically connected to the respective first connection conductors 31 by the connecting portions 43a and 43b. The third conductor 41-2 is configured to be electrically connected to the respective third connection conductors 35 by the connecting portions 43e and 43f. The first connection conductor group 30 and the third connection conductor group 34 may be capacitively connected via the gap 42-1 of the third conductor 41-1 and the gap 42-2 of the third conductor 41-2.

The second conductor 50 is configured to provide a reference potential for the antenna body 10. The second conductor 50 may be configured to be electrically connected to the ground of a device provided with the antenna body 10. As illustrated in FIG. 7, the second conductor 50 is positioned on a Z axis negative direction side of the base 20. A variety of parts of the device provided with the antenna body 10 may be located on the Z axis negative direction side of the second conductor 50. The antenna body 10 has the artificial magnetic conductor character described above even when the variety of parts are located on the Z axis negative direction side of the second conductor 50, enabling the radiation efficiency at the operating frequency to be maintained.

As illustrated in FIG. 6, the second conductor 50 extends along the XY plane. The second conductor 50 may be a conductor having a flat plate shape. The second conductor 50 is separated from the first conductor 40 in the Z direction. The second conductor 50 may face the first conductor 40. The second conductor 50 may have a substantially rectangular shape in accordance with the shape of the first conductor 40. However, the second conductor 50 may have any shape in accordance with the shape of the first conductor 40. A short side of the second conductor 50 having the substantially rectangular shape is along the X direction. A long side of the second conductor 50 having the substantially rectangular shape is along the Y direction. The second conductor 50 may have an opening portion 50A in accordance with the structure of the feed line 60.

As illustrated in FIG. 7, the second conductor 50 includes a fourth conductor 51-1 and a fourth conductor 51-2. Hereinafter, in a case where the fourth conductor 51-1 and the fourth conductor 51-2 are not particularly distinguished, these are collectively referred to as the “fourth conductor 51”.

The fourth conductor 51 may have a substantially rectangular shape. The fourth conductor 51 having the substantially rectangular shape includes four corner portions. The fourth conductor 51-1 faces the third conductor 41-1. The fourth conductor 51-2 faces the third conductor 41-2. One side along the X direction on the Y axis positive direction side of the fourth conductor 51-1 is integrated with one side along the X direction on the Y axis negative direction side of the fourth conductor 51-2. Two corner portions on the Y axis positive direction side of four corner portions of the fourth conductor 51-1 are integrated with two corner portions on the Y axis negative direction side of four corner portions of the fourth conductor 51-2.

The second conductor 50 is electrically connected to the first connection conductor group 30. For example, two corner portions on the Y axis negative direction side of four corner portions of the fourth conductor 51-1 are each configured to be electrically connected to the first connection conductor 31.

The second conductor 50 is configured to be electrically connected to the second connection conductor group 32. For example, on each of the X axis positive direction side and the X axis negative direction side, a corner portion on the Y axis positive direction side of the fourth conductor 51-1 and a corner portion on the Y axis negative direction side of the fourth conductor 51-2 that are integrated are configured to be electrically connected to the second connection conductor 33.

The second conductor 50 is electrically connected to the third connection conductor group 34. For example, two corner portions on the Y axis positive direction side of four corner portions of the fourth conductor 51-2 are each configured to be electrically connected to the third connection conductor 35.

A portion of the feed line 60 is along the Z direction. The feed line 60 may be a conductor having a columnar shape. A portion of the feed line 60 may be located in the region surrounded by the upper portion 21 and the side wall portion 22.

The feed line 60 is electromagnetically connected to the first conductor 40. In the present disclosure, the “electromagnetic connection” may be an electrical connection or a magnetic connection. For example, one end of the feed line 60 may be electrically connected to the first conductor 40. The other end of the feed line 60 may extend externally from the opening portion 50A of the second conductor 50 illustrated in FIG. 6. The other end of the feed line 60 may be electrically connected to an external device or the like.

The feed line 60 supplies electrical power to the first conductor 40. The feed line 60 supplies the electrical power from the first conductor 40 to an external device or the like.

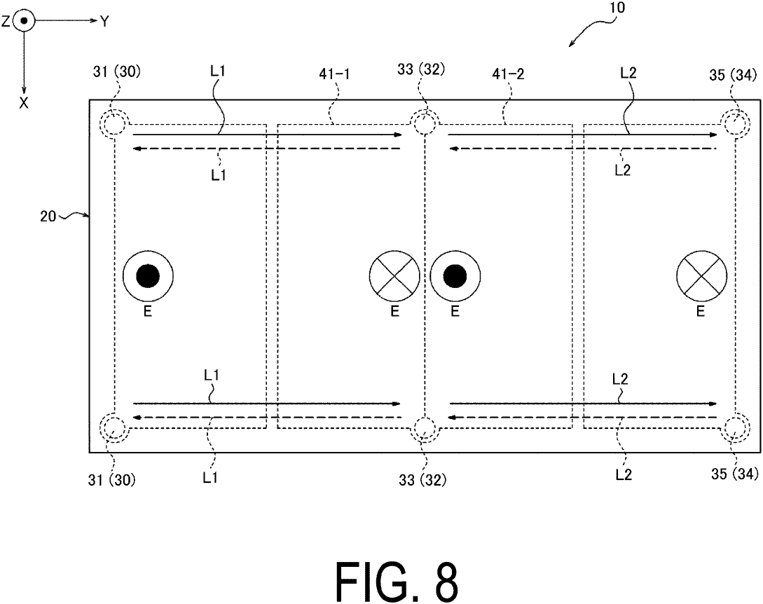

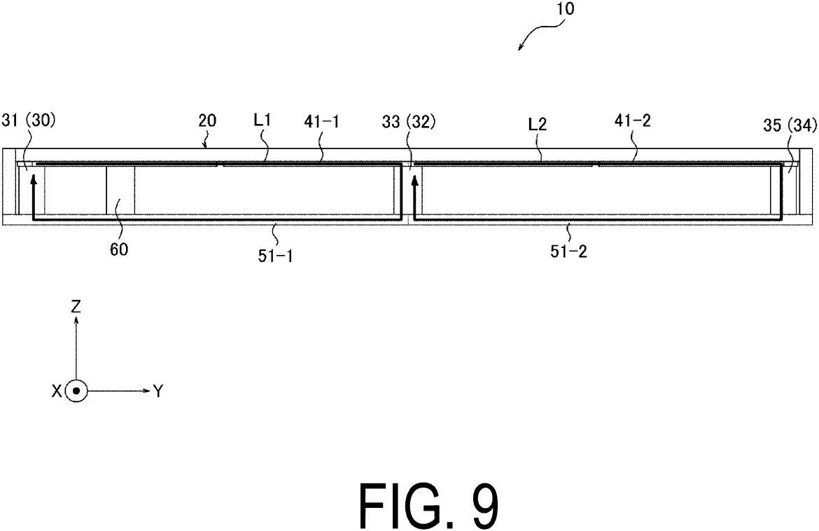

FIG. 8 is a plan view schematically illustrating electrical currents L1 and L2, and an electrical field E when the electromagnetic wave in a first frequency band is radiated. FIG. 8 illustrates the orientations of the electrical field E when viewed from the Z axis positive direction side at a given moment. In FIG. 8, the electrical currents L1 and L2 each denoted by a solid line represent the orientations of the electrical currents flowing through the first conductor 40 when viewed from the Z axis positive direction side at a given moment. The electrical currents L1 and L2 each denoted by a dotted line represent the orientations of the electrical currents flowing through the second conductor 50 when viewed from the Z axis positive direction side at a given moment. FIG. 9 is a cross-sectional view of the state illustrated in FIG. 8.

Appropriately supplying electrical power from the feed line 60 to the first conductor 40 may excite the electrical current L1 and the electrical current L2. The antenna body 10 radiates the electromagnetic wave in the first frequency band by the electrical current L1 and the electrical current L2. The first frequency band is one of the operating frequency bands of the antenna body 10.

The electrical current L1 may be a loop electrical current flowing along a first loop. The first loop may include the first connection conductor group 30, the second connection conductor group 32, the first conductor 40, and the second conductor 50. For example, the first loop may include the first connection conductor 31, the second connection conductor 33, the third conductor 41-1, and the fourth conductor 51-1.

The electrical current L2 may be a loop electrical current flowing along a second loop. The second loop may include the second connection conductor group 32, the third connection conductor group 34, the first conductor 40, and the second conductor 50. For example, the second loop may include the second connection conductor 33, the third connection conductor 35, the third conductor 41-2, and the fourth conductor 51-2.

The orientation of the electrical current L1 flowing through a corresponding portion in the first loop may be identical to the orientation of the electrical current L2 flowing through a corresponding portion in the second loop. For example, the second connection conductor 33 included in the first loop and the third connection conductor 35 included in the second loop are corresponding portions. As illustrated in FIG. 9, the orientation of the electrical current L1 flowing through the second connection conductor 33 included in the first loop and the orientation of the electrical current L2 flowing through the third connection conductor 35 included in the second loop may be, at a given moment, the same Z axis negative direction. The first connection conductor 31 included in the first loop and the second connection conductor 33 included in the second loop are also corresponding portions. At a given moment, the orientation of the electrical current L1 flowing through the first connection conductor 31 included in the first loop and the orientation of the electrical current L2 flowing through the second connection conductor 33 included in the second loop may be the same Z axis positive direction.

By making the orientation of the electrical current L1 flowing through the corresponding portion in the first loop identical to the orientation of the electrical current L2 flowing through the corresponding portion in the second loop, the orientation of the electrical current L1 flowing through the second connection conductor 33 in the first loop may be opposite to the orientation of the electrical current L2 flowing through the second connection conductor 33 of the second loop. For example, when the orientation of the electrical current L1 flowing through the second connection conductor 33 included in the first loop is the Z axis negative direction at a given moment, the orientation of the electrical current L2 flowing through the second connection conductor 33 included in the second loop may be the Z axis positive direction. When the orientations of the electrical current L1 and the electrical current L2 that flow through the second connection conductor 33 are opposite each other, as illustrated in FIG. 8, the orientation, at or near the second connection conductor group 32, of the electrical field generated by the electrical current L1 and the orientation, at or near the second connection conductor group 32, of the electrical field generated by the electrical current L2 may be opposite each other. By making the orientations of the two electrical fields opposite to each other, the electric field at or near the second connection conductor group 32 generated by the electrical current L1 and the electric field at or near the second connection conductor group 32 generated by the electrical current L2 may be offset macroscopically.

By making the orientation of the electrical current L1 flowing through the corresponding portion in the first loop identical to the orientation of the electrical current L2 flowing through the corresponding portion in the second loop, the electrical current L1 and the electrical current L2 may be viewed as one macroscopic loop electrical current. This macroscopic loop electrical current may be viewed as flowing along a loop including the first connection conductor group 30, the third connection conductor group 34, the first conductor 40, and the second conductor 50. The electrical field at or near the first connection conductor group 30 generated by this macroscopic loop electrical current may be opposite to the electrical field at or near the third connection conductor group 34 generated by this macroscopic loop electrical current. For example, as illustrated in FIG. 8, when the orientation of the electrical field at or near the first connection conductor group 30 is the Z axis positive direction, the orientation of the electrical field at or near the third connection conductor group 34 may be the Z axis negative direction.

The macroscopic loop electrical current may cause the first connection conductor group 30 and the third connection conductor group 34 to function as a pair of electrical walls (electric conductor) when viewed from the first conductor 40 as a resonator. Further, the macroscopic loop electrical current may cause a YZ plane on the X axis positive direction side and a YZ plane on the X axis negative direction side to function as a pair of magnetic walls when viewed from the first conductor 40 as a resonator. Surrounding the first conductor 40 by such a pair of electrical walls and such a pair of magnetic walls causes the antenna body 10 to enter a mode exhibiting the artificial magnetic conductor character with respect to the electromagnetic wave in the first frequency band incident on the first conductor 40 from the outside (first mode).

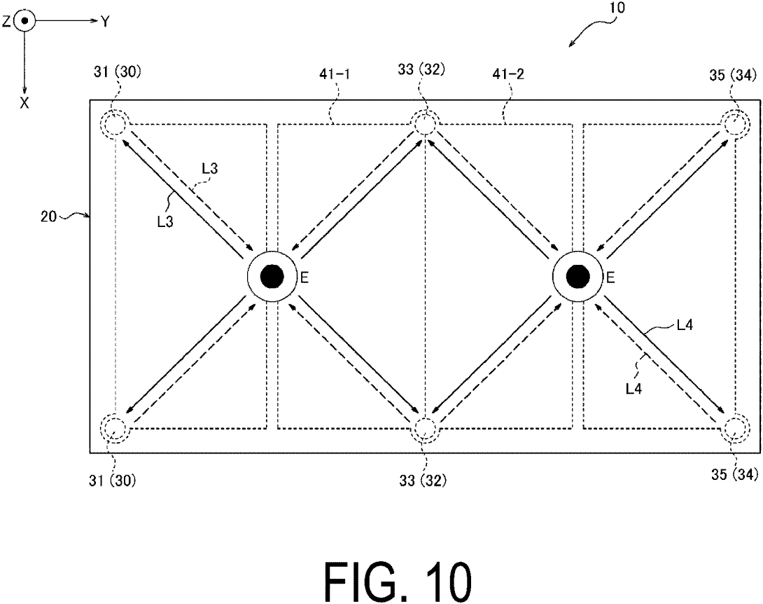

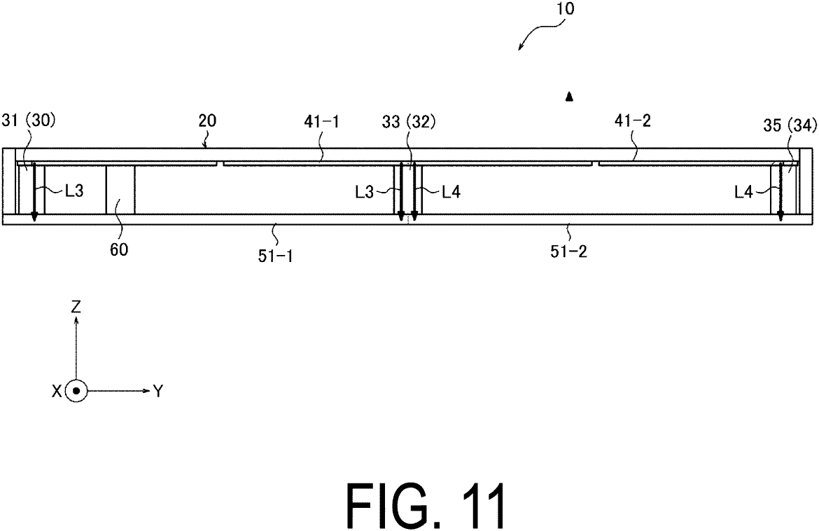

FIG. 10 is a plan view schematically illustrating electrical currents L3, L4, and the electrical field E when the electromagnetic wave in the second frequency band is radiated. FIG. 10 illustrates the orientations of the electrical field E at a given moment when viewed from the Z axis positive direction side. In FIG. 10, the electrical currents L3 and L4 each denoted by a solid line represent the orientations of the electrical currents flowing through the first conductor 40 when viewed from the Z axis positive direction side at a given moment. The electrical currents L3 and L4 each denoted by a dotted line represent the orientations of the electrical currents flowing through the second conductor 50 when viewed from the Z axis positive direction side at a given moment. FIG. 11 is a cross-sectional view of the state illustrated in FIG. 10.

Appropriately supplying electrical power from the feed line 60 to the first conductor 40 may excite the electrical current L3 and the electrical current L4 in the second frequency band. The second frequency band may be one of the operating frequency bands of the antenna body 10. Frequencies belonging to the second frequency band are higher than frequencies belonging to the first frequency band.

The electrical current L3 may flow through the third conductor 41-1 at a given moment from a central region of the third conductor 41-1 toward four corner portions of the third conductor 41-1. The electrical current L3 may flow through the third conductor 41-1 at a different moment from the four corner portions of the third conductor 41-1 toward the central region of the third conductor 41-1.

The electrical current L3 may flow through the fourth conductor 51-1 at a given moment from four corner portions of the fourth conductor 51-1 toward a central region of the fourth conductor 51-1. The electrical current L3 may flow through the fourth conductor 51-1 at a different moment from the central region of the fourth conductor 51-1 toward the four corner portions of the fourth conductor 51-1.

The orientation of the electrical current L3 flowing through the first connection conductor 31 may be identical to the orientation of the electrical current L3 flowing through the second connection conductor 33. For example, as illustrated in FIG. 11, when the orientation of the electrical current L3 flowing through the first connection conductor 31 is the Z axis negative direction at a given moment, the orientation of the electrical current L3 flowing through the second connection conductor 33 may be the Z axis negative direction. At a different moment, when the orientation of the electrical current L3 flowing through the first connection conductor 31 is the Z axis positive direction, the orientation of the electrical current L3 flowing through the second connection conductor 33 may be the Z axis positive direction.

The third conductor 41-1, the fourth conductor 51-1, the first connection conductors 31, and the second connection conductors 33 may constitute a first dielectric resonator. The first dielectric resonator may, with the electrical current L3 excited, resonate in a transverse magnetic (TM) mode (second mode), which is a resonant mode of a dielectric resonator.

At a given moment, the electrical current L4 may flow through the third conductor 41-2 from a vicinity of the center of the third conductor 41-2 toward each of four corner portions of the third conductor 41-2. At a different moment, the electrical current L4 may flow through the third conductor 41-2 from each of the four corner portions of the third conductor 41-2 toward the vicinity of the center of the third conductor 41-2.

At a given moment, the electrical current L4 may flow through the fourth conductor 51-2 from each of four corner portions of the fourth conductor 51-2 toward a vicinity of the center of the fourth conductor 51-2. At a different moment, the electrical current L4 may flow through the fourth conductor 51-2 from the vicinity of the center of the fourth conductor 51-2 toward each of the four corner portions of the fourth conductor 51-2.

The orientation of the electrical current L4 flowing through the second connection conductor 33 and the orientation of the electrical current L4 flowing through the third connection conductor 35 may be the same. For example, as illustrated in FIG. 11, when the orientation of the electrical current L4 flowing through the second connection conductor 33 is the Z axis negative direction at a given moment, the orientation of the electrical current L4 flowing through the third connection conductor 35 may be the Z axis negative direction. At a different moment, when the orientation of the electrical current L4 flowing through the second connection conductor 33 is the Z axis positive direction, the orientation of the electrical current L4 flowing through the third connection conductor 35 may be the Z axis positive direction.

The third conductor 41-2, the fourth conductor 51-2, the second connection conductors 33, and the third connection conductors 35 may constitute a second dielectric resonator. The second dielectric resonator may, with the electrical current L4 excited, resonate in the TM mode, which is a resonant mode of a dielectric resonator.

The antenna body 10 is configured to radiate the electromagnetic wave in the second frequency band by making the orientation of the electrical current flowing through the first connection conductor group 30, the orientation of the electrical current flowing through the second connection conductor group 32, and the orientation of the electrical current flowing through the third connection conductor group 34 identical to one another. For example, the orientation of the electrical current L3 flowing through the first connection conductor 31 and the second connection conductor 33 and the orientation of the electrical current L4 flowing through the second connection conductor 33 and the third connection conductor 35 may be the same. Such a configuration may make the orientation of the electric field on the third conductor 41-1 generated by the electrical current L3 identical to the orientation of the electric field on the third conductor 41-2 generated by the electrical current L4 in the second frequency band.

The antenna body 10 serves as a dielectric resonator antenna in the second frequency band. In the second frequency band, the first dielectric resonator and the second dielectric resonator may resonate in a TM mode of dielectric resonators in the same phase.

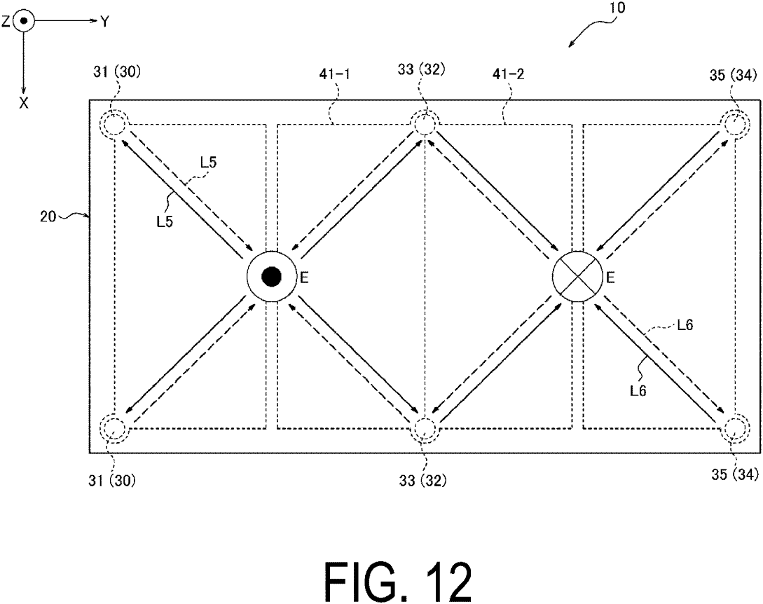

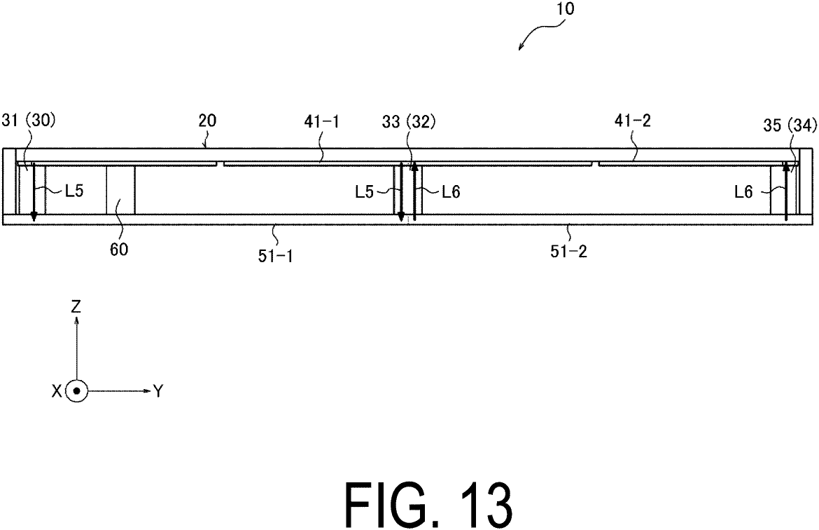

FIG. 12 is a plan view schematically illustrating electrical currents L5, L6, and the electrical field E when the electromagnetic wave in the third frequency band is radiated. FIG. 12 illustrates the orientations of the electrical field E when viewed from the Z axis positive direction side at a given moment. In FIG. 12, the electrical currents L5 and L6 each denoted by a solid line represent the orientations of the electrical currents flowing through the first conductor 40 when viewed from the Z axis positive direction side at a given moment. The electrical currents L5 and L6 each denoted by a dotted line represent the orientations of the electrical currents flowing through the second conductor 50 when viewed from the Z axis positive direction side at a given moment. FIG. 13 is a cross-sectional view of the state illustrated in FIG. 12.

Electrical power may be supplied as appropriate from the feed line 60 to the first conductor 40 to excite the electrical current L5 and the electrical current L6 in the third frequency band. The third frequency band is one of the operating frequency bands of the antenna body 10. Frequencies belonging to the third frequency band are higher than the frequencies belonging to the first frequency band. The third frequency band may be higher than the second frequency band depending on the configuration of the antenna body 10 or the like.

As with the electrical current L3 illustrated in FIG. 10, the electrical current L5 may flow through the third conductor 41-1, the fourth conductor 51-1, the first connection conductor 31, and the second connection conductor 33. The first dielectric resonator may, with the electrical current L5 excited, may resonate in the TM mode, which is a resonant mode of a dielectric resonator.

As with the electrical current L4 illustrated in FIG. 10, the electrical current L6 may flow through the third conductor 41-2, the fourth conductor 51-2, the second connection conductor 33, and the third connection conductor 35. However, the orientation of the electrical current L6 flowing through the second connection conductor 33 and the third connection conductor 35 is opposite to the orientation of the electrical current L5 flowing through the first connection conductor 31 and the second connection conductor 33. The second dielectric resonator may, with the electrical current L6 excited, resonate in a TM mode in an opposite phase from the first dielectric resonator.

The antenna body 10 is configured to radiate the electromagnetic wave in the third frequency band by making the orientation of the electrical current flowing through the first connection conductor group 30 opposite to the orientation of the electrical current flowing through the third connection conductor group 34. For example, the orientation of the electrical current L5 flowing through the first connection conductor 31 and the second connection conductor 33 may be opposite to the orientation of the electrical current flowing through the second connection conductor 33 and the third connection conductor 35. Such a configuration may make the orientation of the electric field on the third conductor 41-1 generated by the electrical current L5 opposite to the orientation of the electric field on the third conductor 41-2 generated by the electrical current L6.

The antenna body 10 serves as a dielectric resonator antenna in the third frequency band. In the third frequency band, the first dielectric resonator and the second dielectric resonator may resonate in a TM mode of dielectric resonators in an opposite phase from each other.

Next, the housing case 13 will be described with reference to FIG. 3 and FIG. 4. The housing case 13 is formed using metal. The metal may be iron or stainless steel and is not particularly limited. The housing case 13 includes a bottom plate 71, a side wall 72, and a flange 73. The housing case 13 is formed in a shape of a box having an opening. The opening of the housing case 13 is formed on the side of the surface where the first conductor 40 of the antenna body 10 is located. In other words, the opening of the housing case 13 is formed on the face on the side through which the electromagnetic wave enters and exits.

The antenna body 10 is installed on the bottom plate 71. The bottom plate 71 is formed in a substantially rectangular shape in accordance with the shape of the antenna body 10. However, the bottom plate 71 may have any shape in accordance with the shape of the antenna body 10.

The side wall 72 is provided to stand from the bottom plate 71 and in the periphery of the antenna body 10 with a distance from the antenna body 10. The side wall 72 is provided at four sides, in accordance with the bottom plate 71 having a substantially rectangular shape, and the side walls 72 at the four sides are arranged in a frame shape. Note that it suffices if at least one side wall 72 is provided. The side wall 72 is not particularly limited as being provided at four side to form a frame shape and may be formed in a cylindrical shape surrounding the periphery of the antenna body 10.

The flange 73 is provided on the opening side of the side wall 72 and is provided outward from the side wall 72. The flange 73 is formed in a flat plate shape and has an opening at the center portion. The cover 14 is attached to the flange 73.

In the housing case 13, a distance D between the antenna body 10 and the side wall 72 in the X direction and the Y direction is λ/8 or more, where λ is the wavelength of the electromagnetic wave transmitted to and received from the antenna body 10. More preferably, the distance in the X direction and the Y direction between the antenna body 10 and the side wall 72 is λ/4. Here, the electromagnetic wave is in a frequency band for transmission and reception in the TM mode, the frequency band being a 2 GHz band, for example. The wavelength λ of the electromagnetic wave at the center frequency in the 2 GHz band is, for example, approximately 16 cm. Therefore, λ/4, which is the distance between the antenna body 10 and the side wall 72, is approximately 40 mm.

The cover 14 closes the opening of the housing case 13. A material including resin is used for the cover 14 that is formed in a flat plate shape. The cover 14 is fixed to the flange 73 by a fastening member such as a screw.

The RF module 12 is disposed in a corner portion of the housing case 13. The RF module 12 may be configured to control electrical power fed to the antenna body 10. The RF module 12 is configured to modulate a baseband signal and supply the resultant signal to the antenna body 10. The RF module 12 may be configured to modulate an electrical signal received by the antenna body 10 into a baseband signal.

The wireless communication module 120 is provided to have the surface, on the opening side of the housing case 13, included in the front of the package receiving box 110. Thus, the wireless communication module 120 can transmit and receive the electromagnetic wave on the front side that is the open space side. Note that the wireless communication module 120 may be provided to have the surface, on the opening side of the housing case 13, included in the top face of the package receiving box 110.

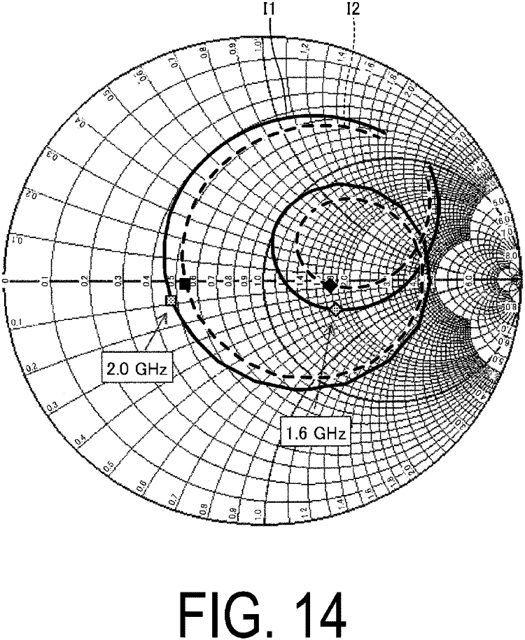

Next, input impedance of the antenna 1 will be described with reference to FIG. 14. FIG. 14 is a diagram illustrating input impedance of the antenna. FIG. 14 is what is known as the Smith chart. In FIG. 14, I1 indicates the input impedance of the antenna 1 not housed in the housing case 13, and I2 indicates the input impedance of the antenna 1 housed in the housing case 13 of the present disclosure. The trajectory of the input impedance I2 is smaller than that of the input impedance I1. For example, when the input impedance I1 and the input impedance I2 when the frequency of the electromagnetic wave is 2.0 GHz are compared, the input impedance I1 is smaller than the input impedance I2. When the input impedance I1 and the input impedance I2 when the frequency of the electromagnetic wave is 1.6 GHz are compared, the input impedances I1 and I2 are substantially the same.

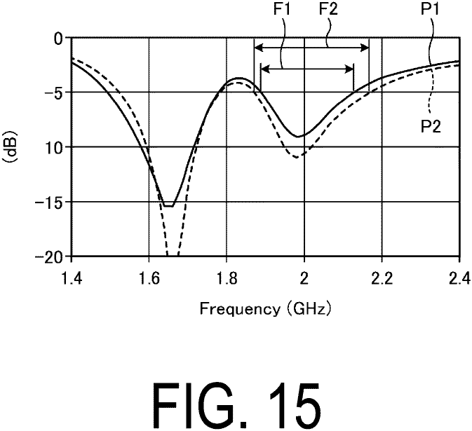

Next, with reference to FIG. 15, the reflection characteristics of the antenna 1 will be described. FIG. 15 is a graph showing an example of reflection characteristics with respect to the frequency of the antenna. The horizontal axis and the vertical axis in FIG. 15 respectively represent the frequency of the electromagnetic wave and reflection coefficient. In FIG. 15, P1 indicates the reflection coefficient of the antenna 1 not housed in the housing case 13, and P2 indicates the reflection coefficient of the antenna 1 housed in the housing case 13 of the present disclosure. For example, when the frequency that is the attenuation pole of the electromagnetic wave is 2.0 GHz, the frequency bands achieving, respectively with P1 and P2, a reflection coefficient smaller than -5 (dB) are a frequency band F1 and a frequency band F2. When compared with the frequency band F1, the frequency band F2 is wider than the frequency band F1.

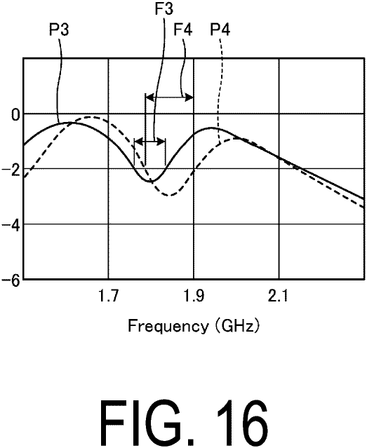

Next, with reference to FIG. 16, the reflection characteristics of the antenna 1 will be described. FIG. 16 is a graph showing an example of reflection characteristics with respect to the frequency of the antenna. The horizontal axis and the vertical axis in FIG. 16 respectively represent the frequency of the electromagnetic wave and reflection coefficient. In FIG. 16, P3 indicates the reflection coefficient of the antenna 1 housed in the housing case 13 of the present disclosure and not closed by the cover 14, and P4 indicates the reflection coefficient of the antenna 1 housed in the housing case 13 of the present disclosure and closed by the cover 14. For example, when the frequency that is the attenuation pole of the electromagnetic wave is 2.0 GHz, the frequency bands achieving, respectively with P3 and P4, a reflection coefficient smaller than -2 (dB) are a frequency band F3 and a frequency band F4. When compared with the frequency band F3, the frequency band F4 is wider than the frequency band F3.

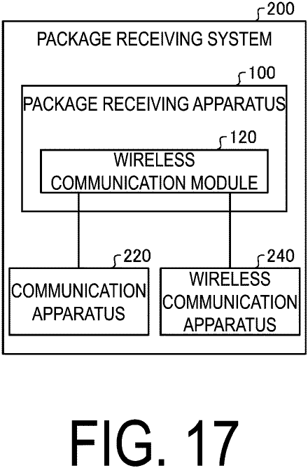

Next, a package receiving system 200 will be described with reference to FIG. 17. FIG. 17 is a diagram illustrating a package receiving system including a package receiving apparatus according to the embodiment. The package receiving system 200 according to the embodiment includes the package receiving apparatus 100 and a communication apparatus 220. The communication apparatus 220 receives information transmitted from the package receiving apparatus 100 via the wireless communication module 120. The communication apparatus 220 may wirelessly communicate directly with the package receiving apparatus or may communicate with the package receiving apparatus via a wireless base station or the like. The communication apparatus 220 may not have a wireless communication function. The communication apparatus 220 may be, for example, a server or the like. The communication apparatus 220 may be on a cloud coupling a plurality of servers or the like. The communication apparatus 220 is managed, for example, by a service operator that operates the system.

The package receiving system 200 may include a wireless communication apparatus 240. The wireless communication apparatus 240 receives information on the package receiving apparatus 100. The wireless communication apparatus 240 may provide information on the package receiving apparatus 100. The wireless communication apparatus 240 may be a wireless communication apparatus for a deliverer. The wireless communication apparatus 240 may receive information on a package housed in the package receiving apparatus 100. The wireless communication apparatus 240 may provide information on a package stored in the package receiving apparatus 100. The wireless communication apparatus 240 may be a wireless communication apparatus for the receiver. The wireless communication apparatus 240 may include a wireless communication apparatus for one or a plurality of deliverers, and a wireless communication apparatus for one or a plurality of receivers. The wireless communication apparatus 240 may be the communication apparatus 220. The wireless communication apparatus 240 may wirelessly communicate with the receiver of the package directly.

Next, an example of an arrangement of the antenna 1 in the package receiving apparatus 100 according to an embodiment will be described. For example, when the package receiving box 110 is provided in a closed space such as a hallway or an entrance, the antenna 1 needs to radiate an electromagnetic wave in an extending direction of the hallway to communicate with an outdoor or indoor spot. For example, the antenna 1 of the package receiving box 110 may have an unstable electromagnetic wave due to the interference when the electromagnetic wave is reflected by an adjacent wall or the like. Thus, the package receiving apparatus 100 according to the embodiment desirably places the antenna 1 to enhance radiation characteristics of the antenna 1.

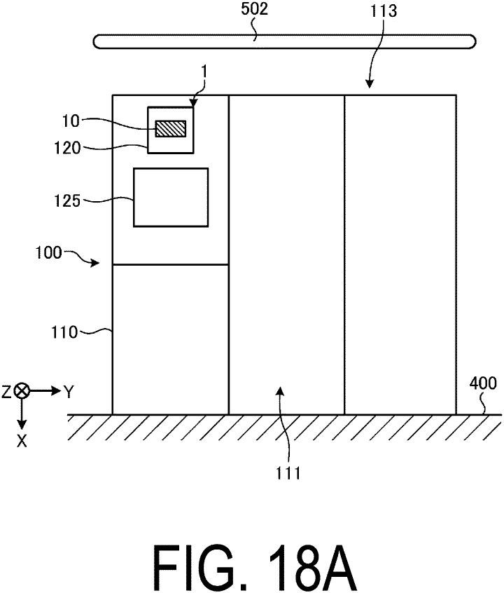

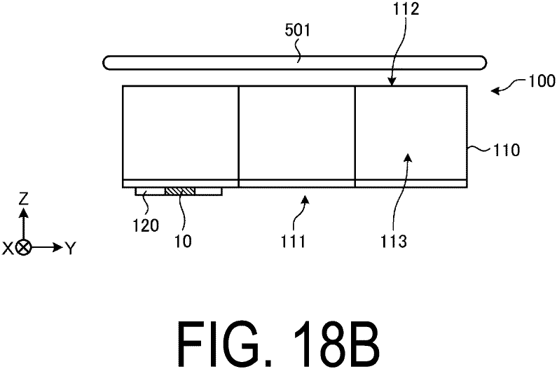

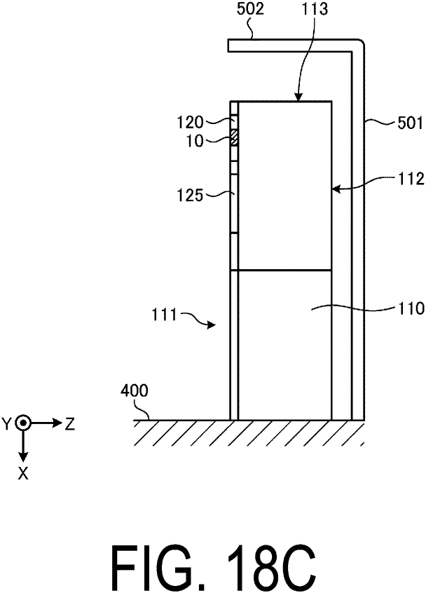

FIG. 18A is a front view illustrating an example of an arrangement of the antenna 1 in the package receiving apparatus 100 according to the embodiment. FIG. 18B is a top view illustrating the example of the arrangement of the antenna 1 in the package receiving apparatus 100 according to the embodiment. FIG. 18C is a side view illustrating the example of the arrangement of the antenna 1 in the package receiving apparatus 100 according to the embodiment.

As illustrated in FIG. 18A to FIG. 18C, the package receiving apparatus 100 includes a package receiving box 110, a wireless communication module 120, and a display 125. The package receiving box 110 is placed on a placement surface 400 parallel to the Y direction and the Z direction, for example. The package receiving box 110 is directly placed on the placement surface 400. The placement surface 400 includes a substantially planar object below the antenna 1 in a transmission space provided with the antenna 1, for example. The placement surface 400 includes a floor of a room and the ground. The placement surface 400 includes a flat surface on which the package receiving box 110 can be placed, a virtual plane of a location to be placed, and a gentle slope. The package receiving box 110 is an example of a case that is a conductor.

For example, the package receiving box 110 is placed on the placement surface 400 to enable a deliverer, a receiver, or the like to access from a front face 111. The package receiving box 110 is placed on the placement surface 400, for example, with the rear face 112 being adjacent to a wall 501 of a placement location. The package receiving box 110 is placed on the placement surface 400, for example, with the upper face 113 facing a ceiling 502 of the placement location. The upper face 113 of the package receiving box 110 differ depending on environment in which the package receiving box 110 is placed. The package receiving box 110 can be placed with the upper face 113 adjacent to the ceiling 502 or with the upper face 113 separated from the ceiling 502. The wireless communication module 120 includes the antenna 1 described above.

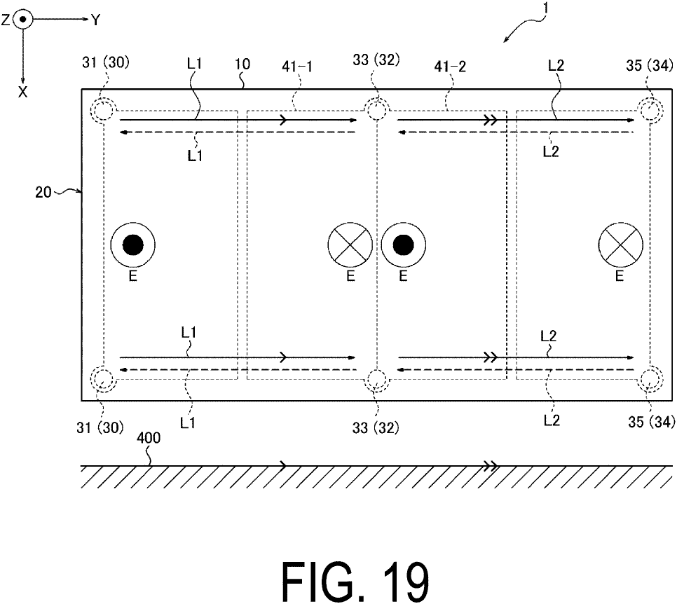

FIG. 19 is a schematic view illustrating an example of relationship between the antenna 1 and the placement surface 400 according to the embodiment. As illustrated in FIG. 19, the antenna body 10 of the antenna 1 is supported by the package receiving box 110 (case) with electrical current directions of the electrical currents L1 and L2 in a mode exhibiting an artificial magnetic conductor character (first mode) being parallel to the placement surface 400. In other words, the antenna body 10 is supported by the package receiving box 110 with the direction of the electrical current excited when the electromagnetic wave is radiated in the first mode being along the placement surface 400. The antenna body 10 is supported by the package receiving box 110 with the first loop and the second loop described above being parallel to the placement surface 400 in the first mode. The electrical current direction being parallel to the placement surface 400 includes the electrical current direction and the placement surface 400 being parallel to each other and the electrical current direction and the placement surface 400 intersecting at an angle formed by the electrical current direction and the placement surface 400 smaller than 45 degrees. In other words, the antenna 1 may be supported by the package receiving box 110 (case) such that the placement surface 400 and the electrical current direction intersect at an angle formed by the placement surface 400 and the electrical current direction smaller than 45 degrees, for example.

The present embodiment describes a case where the antenna 1 is disposed on the front face 111 of the package receiving box 110 but is not limited to the case. The antenna 1 may be disposed on the side face of the package receiving box 110 or the like.

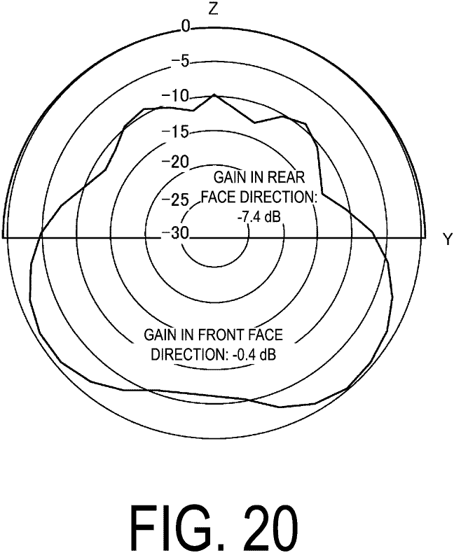

FIG. 20 is a diagram illustrating an example of a radiation pattern in a radiation plane of the antenna 1 illustrated in FIG. 19. The radiation pattern illustrated in FIG. 20 indicates radiation patterns in a front face direction and a rear face direction in the YZ plane of the antenna body 10. The front face direction includes a direction from the antenna body 10 toward the front of the front face 111 of the package receiving box 110. The rear face direction includes a direction from the antenna body 10 toward the rear face 112 of the package receiving box 110.

As illustrated in FIG. 20, when the electrical current directions of the electrical currents L1 and L2 in the first mode are parallel to the placement surface 400, the antenna 1 has characteristics with a gain in the front face direction of -0.4 (dB) and a gain in the rear face direction of -7.4 (dB). In other words, FIG. 20 indicates that the antenna 1 has a higher gain in the front face direction than in the rear face direction, when the electrical current directions of the electrical currents L1 and L2 in the first mode are parallel to the placement surface 400. As a result, the antenna 1 has a radiation pattern with a higher gain than a radiation pattern achieved with known arrangements in a plane in the front of the package receiving box 110, enabling favorable communication with surrounding base stations and the like. In addition, the antenna 1 can reduce radiation to the rear face 112 of the package receiving box 110, enabling stable communication without interference with reflected waves from the wall 501.

Next, comparative examples of electromagnetic wave pattern between the arrangement of the antenna 1 according to the embodiment and a plurality of other arrangement examples will be described below.

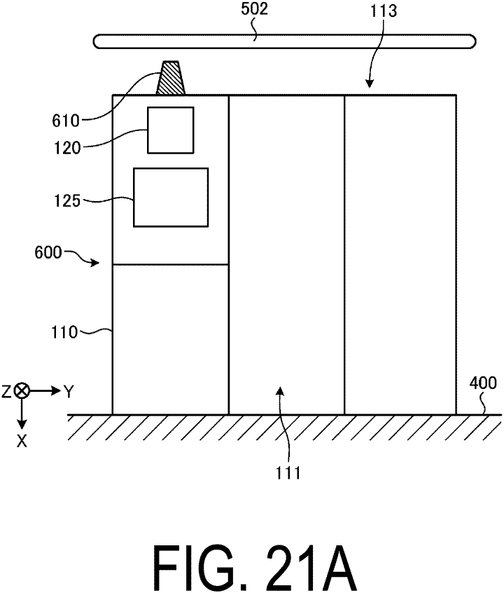

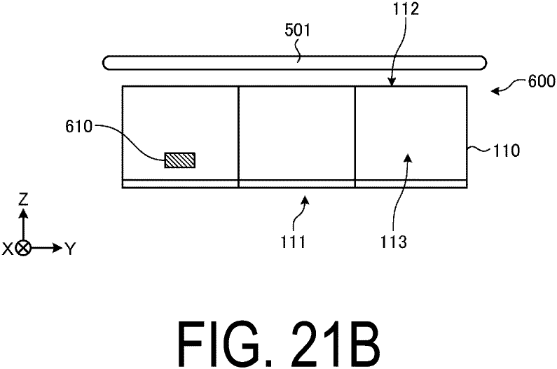

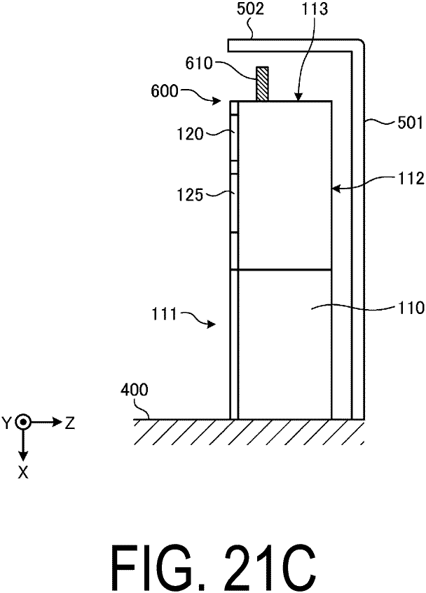

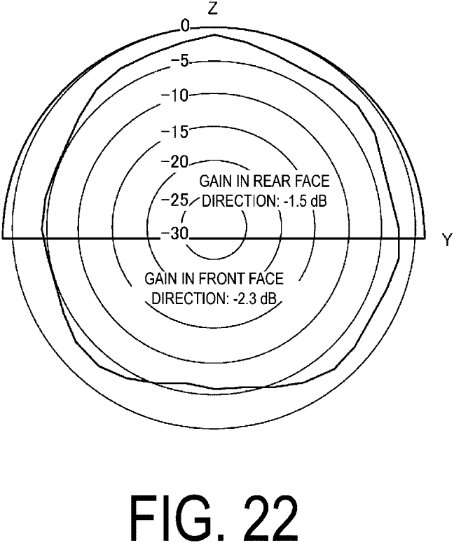

A case where a dipole antenna is disposed in the package receiving box 110 will be described with reference to FIG. 21 and FIG. 22. FIG. 21A is a front view illustrating an example of a package receiving apparatus according to Reference Example (1). FIG. 21B is a top view illustrating the example of the package receiving apparatus according to Reference Example (1). FIG. 21C is a side view illustrating the example of the package receiving apparatus according to Reference Example (1).

As illustrated in FIG. 21A to FIG. 21C, a package receiving apparatus 600 includes the package receiving box 110, the wireless communication module 120, and the display 125. The package receiving box 110 is placed on the placement surface 400 as described above.

The package receiving apparatus 600 includes a dipole antenna 610 instead of the antenna 1 described above. The dipole antenna 610 is, for example, an antenna with an isotropic radiation pattern. The dipole antenna 610 is provided on the upper face 113 of the package receiving box 110 protruding from the upper face 113 toward the ceiling 502. The dipole antenna 610 is provided on the upper face 113 of the package receiving box 110 with a distal end portion positioned in the vicinity of the ceiling 502. The dipole antenna 610 is included in the wireless communication module 120. The dipole antenna 610 is electrically connected to the controller 130 described above.

FIG. 22 is a diagram illustrating an example of a radiation pattern of the dipole antenna 610 according to Reference Example (1) illustrated in FIG. 21. The radiation pattern illustrated in FIG. 22 indicates radiation patterns in a front face direction and a rear face direction in the YZ plane of the dipole antenna 610. The front face direction includes a direction from the dipole antenna 610 toward the front of the front face 111 of the package receiving box 110. The rear face direction includes a direction from the dipole antenna 610 toward the rear face 112 of the package receiving box 110.

As illustrated in FIG. 22, when an electromagnetic wave is radiated, measurement results that the dipole antenna 610 had a gain in the front face direction of -2.3 (dB) and a gain in the rear face direction of -1.5 (dB) were obtained. In other words, FIG. 22 indicates that the gain of the dipole antenna 610 in the rear face direction toward the wall 501 is high and interference with the reflected waves from the wall 501 can have a negative effect. FIG. 22 indicates that the dipole antenna 610 has a low gain in the front face direction compared to the radiation pattern of the antenna 1 according to the embodiment illustrated in FIG. 20.

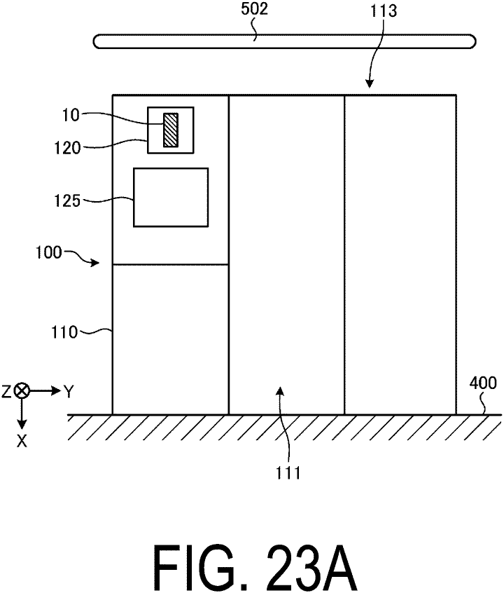

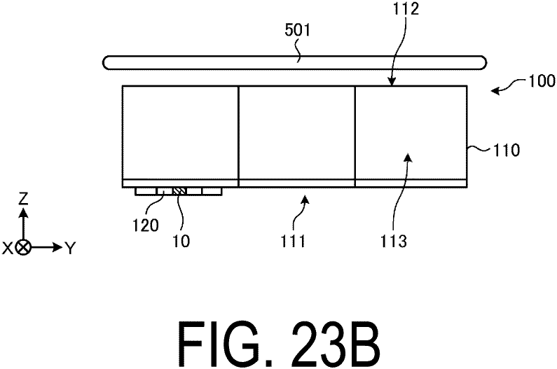

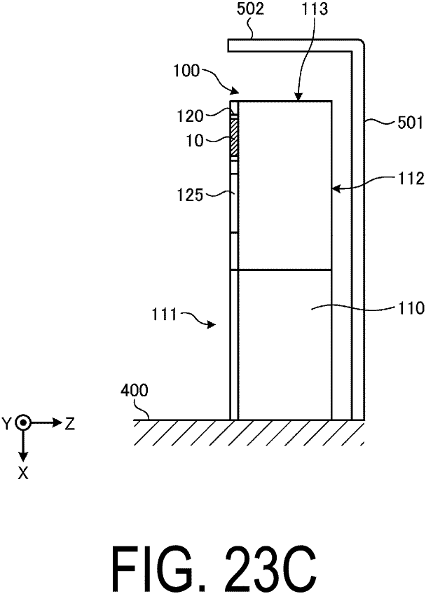

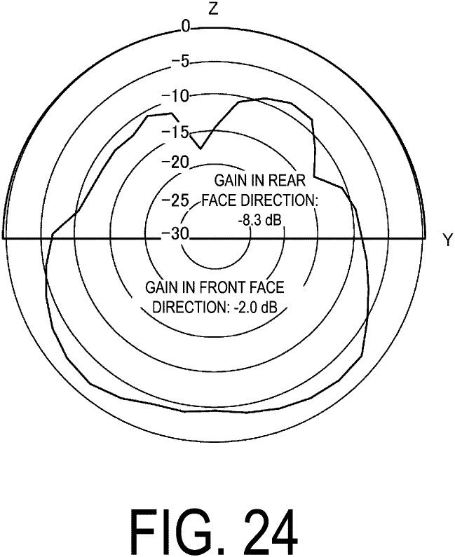

Reference Example (2) where an orientation of an arrangement of the antenna 1 according to the embodiment described above is changed will be described with reference to FIG. 23 and FIG. 24. FIG. 23A is a front view illustrating an example of an arrangement of the antenna 1 in the package receiving apparatus 100 according to Reference Example (2). FIG. 23B is a top view illustrating the example of the arrangement of the antenna 1 in the package receiving apparatus 100 according to Reference Example (2). FIG. 23C is a side view illustrating the example of the arrangement of the antenna 1 in the package receiving apparatus 100 according to Reference Example (2).

As illustrated in FIG. 23A to FIG. 23C, the package receiving apparatus 100 includes the package receiving box 110, the wireless communication module 120, and the display 125. The package receiving box 110 is placed on the placement surface 400 parallel to the Y axis direction and the Z axis direction, as described above. The wireless communication module 120 includes the antenna 1 according to the embodiment described above.

The antenna body 10 of the antenna 1 is supported by the package receiving box 110 (case) with electrical current directions of the electrical currents L1 and L2 in a mode exhibiting an artificial magnetic conductor character (first mode) intersecting with the placement surface 400. In other words, the antenna body 10 is supported by the package receiving box 110 with the direction of the electrical current excited when the electromagnetic wave is radiated in the first mode being along the X axis direction and orthogonal to the placement surface 400. In other words, unlike in the embodiment described above, the antenna body 10 is supported by the package receiving box 110 with the direction of the electrical current excited when the electromagnetic wave is radiated in the first mode, not being along the placement surface 400.

FIG. 24 is a diagram illustrating an example of a radiation pattern in a radiation plane of the antenna 1 of Reference Example (2) illustrated in FIG. 23. The radiation pattern illustrated in FIG. 24 indicates radiation patterns in a front face direction and a rear face direction in the YZ plane of the antenna body 10. The front face direction includes a direction from the antenna body 10 toward the front of the front face 111 of the package receiving box 110. The rear face direction includes a direction from the antenna body 10 toward the rear face 112 of the package receiving box 110.

As illustrated in FIG. 24, when the electrical current directions of the electrical currents L1 and L2 in the first mode are orthogonal to the placement surface 400, measurement results that the antenna 1 according to Reference Example (2) had a gain in the front face direction of -2.0 (dB) and a gain in the rear face direction of -8.3 (dB) were obtained. In other words, FIG. 24 indicates that the antenna 1 according to Reference Example (2) with the electrical current directions of the electrical currents L1 and L2 in the first mode being orthogonal to the placement surface 400 has a low gain in the front face direction compared to the radiation pattern of the antenna 1 according to the embodiment illustrated in FIG. 20.

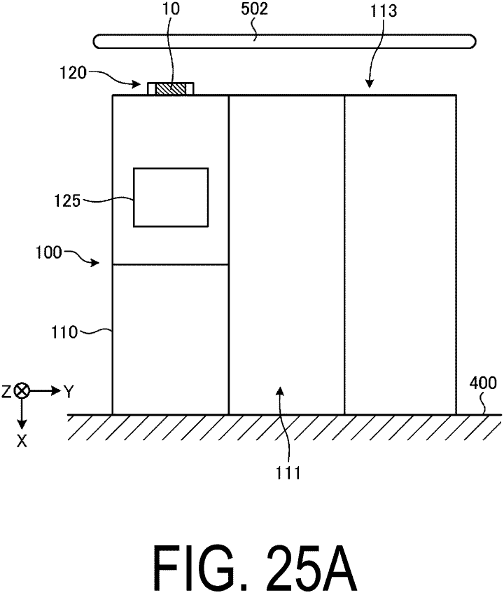

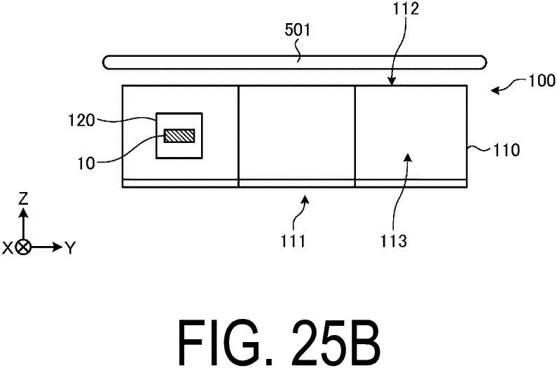

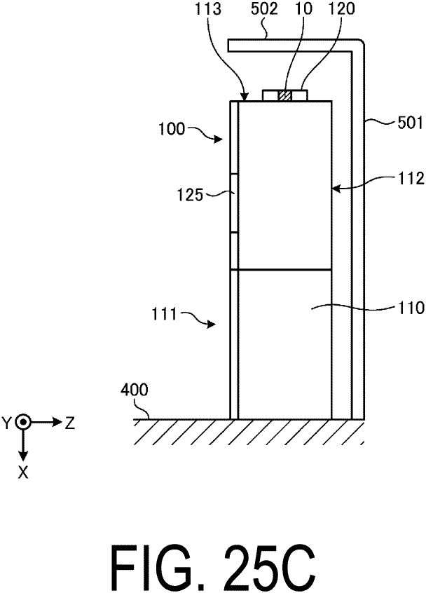

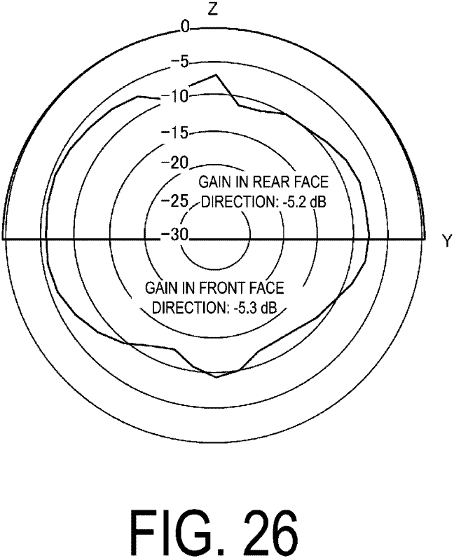

Reference Example (3) where the arrangement of the antenna 1 according to the embodiment described above relative to the package receiving box 110 is changed will be described with reference to FIG. 25 and FIG. 26. FIG. 25A is a front view illustrating an example of an arrangement of the antenna 1 in the package receiving apparatus 100 according to Reference Example (3). FIG. 25B is a top view illustrating the example of the arrangement of the antenna 1 in the package receiving apparatus 100 according to Reference Example (3). FIG. 25C is a side view illustrating the example of the arrangement of the antenna 1 in the package receiving apparatus 100 according to Reference Example (3).

As illustrated in FIG. 25A to FIG. 25C, the package receiving apparatus 100 includes the package receiving box 110, the wireless communication module 120, and the display 125. The package receiving box 110 is placed on the placement surface 400 parallel to the Y axis direction and the Z axis direction, as described above. The wireless communication module 120 is disposed on the upper face 113 of the package receiving box 110. The wireless communication module 120 includes the antenna 1 described above.

The antenna body 10 of the antenna 1 is supported by the package receiving box 110 (case) with electrical current directions of the electrical currents L1 and L2 in a mode exhibiting an artificial magnetic conductor character (first mode) being parallel to the placement surface 400. The antenna body 10 according to Reference Example (3) is supported by the package receiving box 110 with the direction of the electrical current excited when the electromagnetic wave is radiated in the first mode, being parallel to the placement surface 400. In other words, the antenna body 10 is supported by the package receiving box 110 to radiate the electromagnetic wave toward the ceiling 502 above, instead of the front of the package receiving box 110.

FIG. 26 is a diagram illustrating an example of a radiation pattern of the antenna 1 of Reference Example (3) illustrated in FIG. 25. The radiation pattern illustrated in FIG. 26 indicates radiation patterns in a front face direction and a rear face direction in the YZ plane of the antenna body 10 provided on the upper face 113 of the package receiving box 110. The front face direction includes a direction from the antenna body 10 toward the front of the front face 111 of the package receiving box 110. The rear face direction includes a direction from the antenna body 10 toward the rear face 112 of the package receiving box 110.

As illustrated in FIG. 26, when the electrical current directions of the electrical currents L1 and L2 in the first mode are parallel to the placement surface 400, measurement results that the antenna 1 according to Reference Example (3) had a gain in the front face direction of -5.3 (dB) and a gain in the rear face direction of -5.2 (dB) were obtained. In other words, FIG. 26 indicates that the antenna 1 according to Reference Example (3) has a low gain in the front face direction also with the electrical current directions of the electrical currents L1 and L2 in the first mode being parallel to the placement surface 400 compared to the radiation pattern of the antenna 1 according to the embodiment illustrated in FIG. 20.

As described above, the antenna 1 according to the embodiment is supported by the package receiving box 110 with the electrical current directions of the electrical currents L1 and L2 in the first mode being parallel to the placement surface 400, allowing a gain of the electromagnetic wave in the front face direction of the package receiving box 110 to be improved. In addition, the antenna 1 can reduce radiation of the electromagnetic wave in the rear face direction of the package receiving box 110, enabling stable communication without interference with the reflected waves from the wall or the like. As a result, the antenna 1 has a radiation pattern directed in the front face direction of the package receiving box 110, enabling favorable communication.

In addition, the antenna 1 according to the embodiment enables the antenna body 10 to be supported by the package receiving box 110 with the electrical current directions excited when the electromagnetic wave is radiated in the first mode being along the placement surface 400. As a result, the antenna 1 can achieve a gain with a radiation pattern suitable for communication even in an environment with an open portion such as a doorway on the front face side of the package receiving box 110.

In addition, since the package receiving box 110 (case) is a conductor, even disposing the antenna body 10 on the front face 111 of the package receiving box 110 enables the antenna 1 according to the embodiment to achieve a radiation pattern with a high gain in the front face direction. As a result, the antenna 1 enables favorable communication with a base station or the like outside the package receiving box 110.

Furthermore, in the antenna 1 according to the embodiment, housing the antenna body 10 in the housing case 13 made of metal and including the bottom plate 71 and the side wall 72 can reduce the input impedance of the antenna body 10, enabling a broader band of the antenna body 10.

Furthermore, in the antenna 1 according to the embodiment, setting the distance between the antenna body 10 and the side wall 72 to λ/8 or more, more preferably λ/4, allows the input impedance of the antenna body 10 to be appropriately reduced, enabling a wider bandwidth of the antenna body 10 to be appropriately achieved.

Furthermore, in the antenna 1 according to the embodiment, providing the cover 14 that is made of resin and configured to close the opening of the housing case 13 allows a further wider bandwidth of the antenna body 10 to be achieved.

Furthermore, with the wireless communication module 120 according to the embodiment, wireless communications can be performed using the antenna 1 having high antenna efficiency.

Furthermore, with the package receiving apparatus 100 according to the embodiment, wireless communications can be favorably performed with the outside by using the wireless communication module 120.

With the package receiving apparatus 100 according to the embodiment, the antenna 1 opening side face of the wireless communication module 120 can be the front of the package receiving box 110. Thus, the electromagnetic wave can be transmitted and received on the open space side, whereby the occurrence of communication failure due a radio wave shielding object can be suppressed.

The package receiving system 200 according to the embodiment can transmit and receive various types of information between the package receiving apparatus 100 and the communication apparatus 220 and between the package receiving apparatus 100 and the wireless communication apparatus 240.

The embodiment described above describes a case where the package receiving apparatus 100 is configured such that the package receiving box 110 (case) is directly placed on the placement surface 400 but is not limited to the configuration. For example, the package receiving apparatus 100 may include the package receiving box 110 (case) placed on the placement surface 400 via a placement member.

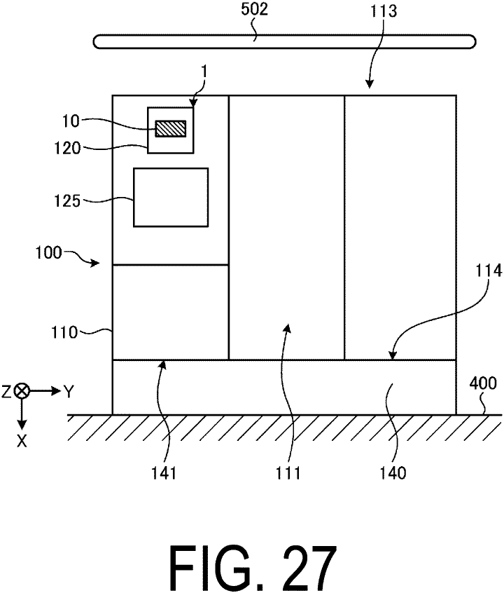

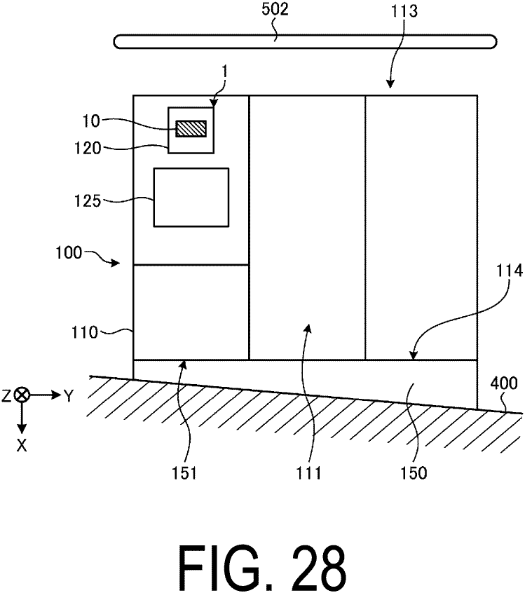

FIG. 27 and FIG. 28 are front views illustrating another example of placement of a package receiving apparatus 100 according to an embodiment.

In an example illustrated in FIG. 27, the package receiving apparatus 100 includes the package receiving box 110 placed on the placement surface 400 via a pedestal 140. The placement surface 400 is, for example, a horizontal floor, ground, or the like. The pedestal 140 is an example of a placement member. The pedestal 140 includes a sill and a plurality of legs. The pedestal 140 is provided on the placement surface 400 with an upper face 141 being parallel to the placement surface 400. For example, the package receiving box 110 is provided on the upper face 141 of the pedestal 140 with a lower face 114 facing the placement surface 400. The package receiving box 110 is placed on the placement surface 400, for example, with the upper face 113 facing the ceiling 502 of the placement location. The pedestal 140 may be included in the configuration of the package receiving apparatus 100.

The antenna body 10 of the antenna 1 is supported by the package receiving box 110 (case) with electrical current directions of the electrical currents L1 and L2 in a mode exhibiting an artificial magnetic conductor character (first mode) being parallel to the placement surface 400. In other words, the antenna body 10 is supported by the package receiving box 110 provided on the pedestal 140 with the direction of the electrical current excited when the electromagnetic wave is radiated in the first mode, being along the placement surface 400. The antenna body 10 is supported by the package receiving box 110 with the first loop and the second loop described above being parallel to the placement surface 400 in the first mode.

In an example illustrated in FIG. 27, the antenna 1 is supported by the package receiving box 110 with the electrical current directions of the electrical currents L1 and L2 in the first mode being parallel to the placement surface 400, allowing a gain of the electromagnetic wave in the front face direction of the package receiving box 110 to be improved. As a result, the antenna 1 has a radiation pattern directed in the front face direction of the package receiving box 110, enabling favorable communication as in the embodiment described above.

In an example illustrated in FIG. 28, the package receiving apparatus 100 includes the package receiving box 110 placed on the placement surface 400 via a pedestal 150. The placement surface 400 is, for example, is a slope within a tolerable range. The slope within a tolerable range includes a floor and ground having an angle formed with a horizontal plane smaller than 45 degrees, for example. The pedestal 150 is an example of a placement member. The pedestal 150 includes a sill and a plurality of legs. The pedestal 150 is provided on the placement surface 400 with an upper face 151 being parallel to the horizontal plane. The upper face 151 of the pedestal 150 has an angle formed with the placement surface 400 within a tolerable range. For example, the package receiving box 110 is provided on the pedestal 150 with the lower face 114 facing the placement surface 400. The package receiving box 110 is placed on the placement surface 400, for example, with the upper face 113 facing the ceiling 502 of the placement location.

The antenna body 10 of the antenna 1 is supported by the package receiving box 110 (case) with electrical current directions of the electrical currents L1 and L2 in a mode exhibiting an artificial magnetic conductor character (first mode) being substantially parallel to the placement surface 400. In other words, the antenna body 10 is supported by the package receiving box 110 provided on the pedestal 150 with the direction of the electrical current excited when the electromagnetic wave is radiated in the first mode, being along the placement surface 400. The antenna body 10 is supported by the package receiving box 110 with the first loop and the second loop described above being parallel to the placement surface 400 in the first mode.

In an example illustrated in FIG. 28, the antenna 1 is supported by the package receiving box 110 with the electrical current directions of the electrical currents L1 and L2 in the first mode being substantially parallel to the placement surface 400, allowing a gain of the electromagnetic wave in the front face direction of the package receiving box 110 to be improved. As a result, the antenna 1 has a radiation pattern directed in the front face direction of the package receiving box 110, enabling favorable communication as in the embodiment described above.

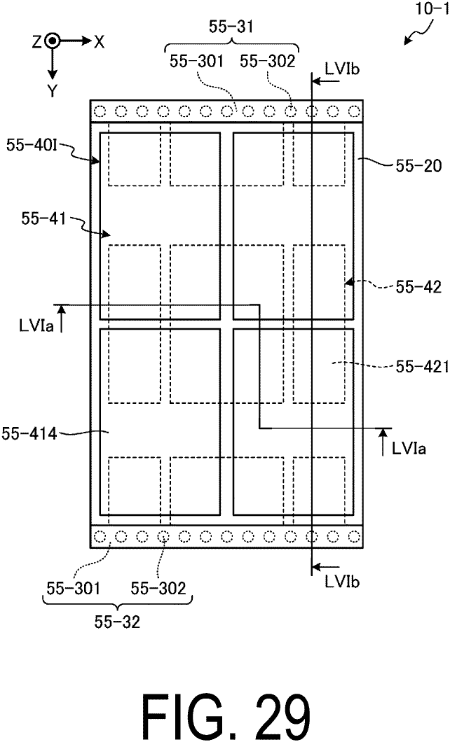

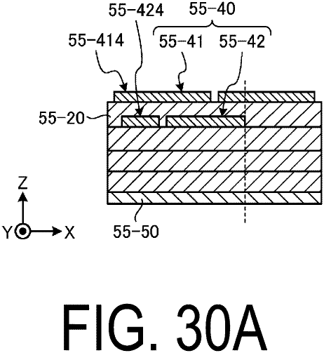

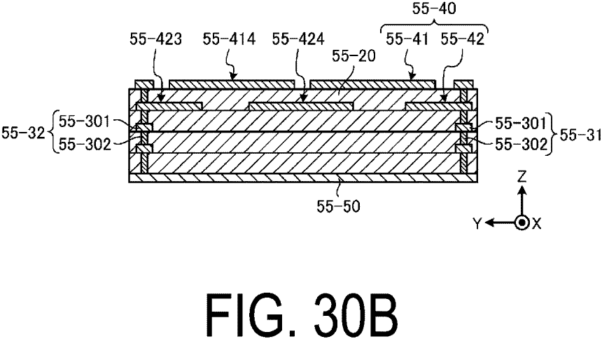

The antenna body 10 according to the embodiment described above can be replaced with another antenna body. FIG. 29 is a diagram illustrating another example of the antenna body 10. FIG. 30A is a cross-sectional view taken along line LVIa-LVIa illustrated in FIG. 29. FIG. 30B is a cross-sectional view taken along line LVIb-LVIb illustrated in FIG. 29.

As illustrated in FIG. 29, FIG. 30A, and FIG. 30B, an antenna body 10-1 includes a first conductor 55-31, a second conductor 55-32, a third conductor 55-40, and a fourth conductor 55-50. The antenna body 10-1 has a feed line not illustrated electromagnetically connected to the third conductor 55-40. The second conductor 55-32 faces the first conductor 55-31 in a first direction. The first direction is, for example, the Y axis direction in FIG. 29. The first conductor 55-31 and the second conductor 55-32 are provided along a second direction (X axis direction) intersecting the first direction. Each of the first conductor 55-31 and the second conductor 55-32 may include at least one fifth conductor layer 55-301 and a plurality of fifth conductors 55-302.

The fifth conductor layer 55-301 is a layer-shaped conductor. The fifth conductor layer 55-301 may be positioned on a base 55-20. The fifth conductor layer 55-301 may be positioned in the base 55-20. The plurality of fifth conductor layers 55-301 are separated from one another in the Z axis direction. The plurality of fifth conductor layers 55-301 are arranged in the Z axis direction. The plurality of fifth conductor layers 55-301 partially overlap in the Z axis direction. The fifth conductor layer 55-301 is configured to electrically connect the plurality of fifth conductors 55-302. The fifth conductor layer 55-301 serves as a connection conductor that connects the plurality of fifth conductors 55-302. The fifth conductor layer 55-301 may be electrically connected to any of conductor layers of the third conductor 55-40. In the embodiment, the fifth conductor layer 55-301 is configured to be electrically connected to a second conductor layer 55-42. The fifth conductor layer 55-301 may be integrated with the second conductor layer 55-42. In the embodiment, the fifth conductor layer 55-301 may be electrically connected with the fourth conductor 55-50. The fifth conductor layer 55-301 may be integrated with the fourth conductor 55-50.

The fifth conductors 55-302 extend in the Z axis direction. The plurality of fifth conductors 55-302 are separated from each other in the Y axis direction. At least part of the plurality of fifth conductors 55-302 is electrically connected to the fourth conductor 55-50. In the embodiment, part of the plurality of fifth conductors 55-302 may electrically connect the fourth conductor 55-50 with the fifth conductor layer 55-301. In one embodiment, the plurality of fifth conductors 55-302 may be electrically connected to the fourth conductor 55-50 via the fifth conductor layer 55-301. Part of the plurality of fifth conductors 55-302 may electrically connect one fifth conductor layer 55-301 with another fifth conductor layer 55-301. As the fifth conductor 55-302, a via conductor and a through-hole conductor may be employed.

The third conductor 55-40 includes the first conductor layer 55-41 and the second conductor layer 55-42. The first conductor layer 55-41 includes four first floating conductors 55-414. In the antenna body 10-1, the second conductor layer 55-42 includes six second connection conductors 55-423 and three second floating conductors 55-424. Each of the two second connection conductors 55-423 is configured to be capacitively coupled to two first floating conductors 55-414. One second floating conductor 55-424 is configured to be capacitively coupled to four first floating conductors 55-414. The two second floating conductors 55-424 are configured to be capacitively coupled to two first floating conductors 55-414. The second conductor layer 55-42 may include a plurality of second unit conductors 55-421 arranged in XY directions. The second unit conductors 55-421 may be arranged to form a square lattice, an oblique lattice, a rectangular lattice, and a hexagonal lattice.

The antenna body 10-1 includes the third conductor 55-40 that functions as a resonator between two first conductors 55-31 facing each other in the Y axis direction and the second conductor 55-32. The two conductors, that is, the first conductor 55-31 and the second conductor 55-32 can be regarded as an electrical wall that extends from the third conductor 55-40 in the XZ plane. The antenna body 10-1 has an end in the X axis direction electrically released. The antenna body 10-1 has a high impedance at ZY planes at both ends in the X axis direction. The ZY planes at both ends of the antenna body 10-1 in the X axis direction can be regarded as magnetic walls from the third conductor 55-40. With the antenna body 10-1 surrounded by the two electrical walls and the two high impedance planes (magnetic walls), the third conductor 55-40 serving as the resonator has an artificial magnetic conductor character in the Z axis direction. With the surrounding by the two electrical walls and the two high impedance planes, the third conductor 55-40 serving as the resonator has a limited number of artificial magnetic conductor characters.

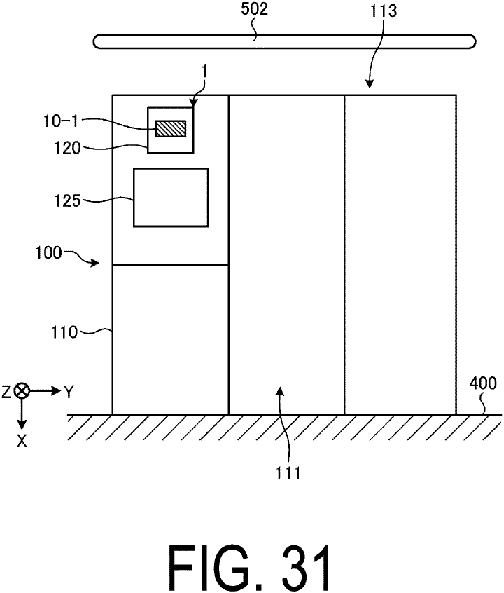

FIG. 31 is a front view illustrating another example of an arrangement of the antenna 1 in the package receiving apparatus 100 according to the embodiment. As illustrated in FIG. 31, the package receiving apparatus 100 includes the package receiving box 110, the wireless communication module 120, and the display 125. The package receiving box 110 is placed on the placement surface 400 parallel to the Y axis direction and the Z axis direction, as described above. The wireless communication module 120 includes the antenna 1.

The antenna 1 includes: the antenna body 10-1 including the first conductor 55-31, the second conductor 55-32 facing the first conductor 55-31 in the first direction, the plurality of third conductors 55-40 that are positioned between the first conductor 55-31 and the second conductor 55-32 and extend along the first direction (Y axis direction), and the fourth conductor 55-50 that is connected to the first conductor 55-31 and the second conductor 55-32, and extends along the first direction; and the package receiving box 110 (case) configured support the antenna body 10-1 and to be placed on the placement surface 400. The antenna body 10-1 is supported by the package receiving box 110 with the first direction being parallel to the placement surface 400.

As described above, the antenna 1 according to the embodiment is supported by the package receiving box 110 with the first direction of the antenna body 10-1 being parallel to the placement surface 400, allowing a gain of electromagnetic wave in the front face direction of the package receiving box 110 to be improved. In addition, the antenna 1 can reduce radiation of the electromagnetic wave in the rear face direction of the package receiving box 110, enabling stable communication without interference with the reflected waves from the wall or the like. As a result, the antenna 1 has a radiation pattern directed in the front face direction of the package receiving box 110, enabling favorable communication.

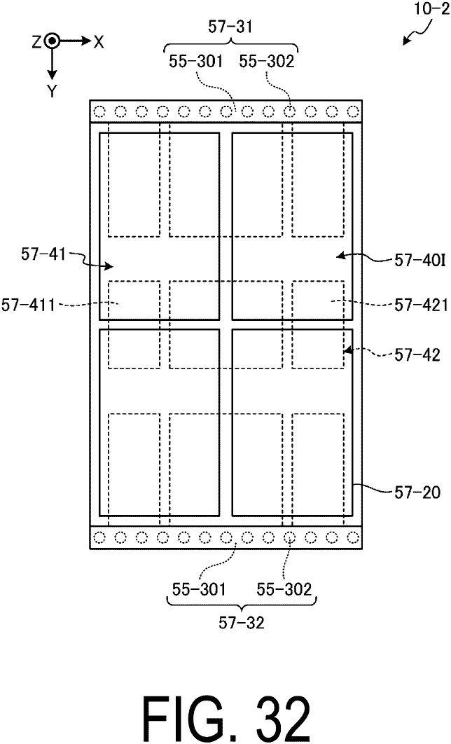

FIG. 32 is a diagram illustrating another example of the antenna body 10-1 illustrated in FIG. 29. An antenna body 10-2 illustrated in FIG. 32 has the same basic configuration as the antenna body 10-1 illustrated in FIG. 29. The antenna body 10-2 includes a first conductor 57-31 and a second conductor 57-32. The first conductor 57-31 and the second conductor 57-32 include the fifth conductor layer 55-301 and the plurality of fifth conductors 55-302. A first conductor layer 57-41 of the antenna body 10-2 includes the four first floating conductors 55-414 described above. A second conductor layer 57-42 includes the six second connection conductors 55-423 and the three second floating conductors 55-424. The antenna body 10-2 has the second conductor layer 57-42 having a size different from that of the second conductor layer 55-42 of the antenna body 10-1. The antenna body 10-2 has a length of the second floating conductors 55-424 along the Y axis direction being shorter than the length of the second connection conductors 55-423 along the X axis direction. An antenna 1 according to the embodiment includes the antenna body 10-2. The antenna 1 is supported by the package receiving box 110 with the first direction of the antenna body 10-2 being parallel to the placement surface 400.

Embodiments have been described in order to fully and clearly disclose the technology according to the appended claims. However, the appended claims are not to be limited to the embodiments described above and should be configured to embody all modifications and alternative configurations that those skilled in the art may make within the underlying matter set forth herein.

1. An antenna, comprising:
an antenna body configured to radiate an electromagnetic wave when entering a first mode exhibiting an artificial magnetic conductor character with respect to an electromagnetic wave in a first frequency band and entering a second mode serving as a resonator for the electromagnetic wave in a second frequency band higher than the first frequency band; and
a case configured to support the antenna body and to be placed on a placement surface directly or via a placement member, wherein
the antenna body is supported by the case with a direction of an electrical current in the first mode being parallel to the placement surface.

2. The antenna according to claim 1, wherein the antenna body is supported by the case with the direction of the electrical current excited when the electromagnetic wave is radiated in the first mode being along the placement surface.

3. An antenna, comprising:
an antenna body comprising:
a first conductor;
a second conductor facing the first conductor in a first direction;
a plurality of third conductors positioned between the first conductor and the second conductor and extending along the first direction;
a fourth conductor connected to the first conductor and the second conductor and extending along the first direction; and
a feed line electromagnetically connected to the third conductor; and
a case configured to support the antenna body and to be placed on a placement surface, wherein
the antenna body is supported by the case with the first direction being parallel to the placement surface.

4. The antenna according to claim 1, wherein the case is a conductor.

5. The antenna according to claim 1, wherein the case includes a housing case made of metal including a bottom plate on which the antenna body is installed and a side wall installed upright from the bottom plate and spaced from a periphery of the antenna body with a distance and having, as an opening, a face through which the electromagnetic wave enters and exits.

6. The antenna according to claim 5, wherein the distance between the antenna body and the side wall is λ/8 or more, where λ is a wavelength of the electromagnetic wave.

7. The antenna according to claim 6, wherein the distance between the antenna body and the side wall is λ/4.

8. The antenna according to claim 5, further comprising a cover made of resin and configured to close the opening of the housing case.

9. A wireless communication module, comprising:
the antenna according to claim 4; and
an RF module housed in the housing case and electrically connected to the antenna body.

10. A package receiving apparatus, comprising:
the wireless communication module according to claim 9;
a package receiving box provided with the wireless communication module and configured to house a package; and
a controller electrically connected to the wireless communication module and configured to manage the package housed in the package receiving box, wherein
the case is the package receiving box.

11. The package receiving apparatus according to claim 10, wherein the wireless communication module is provided with a face on a side of the opening of the antenna facing a front of the package receiving box.

12. A package receiving system, comprising:
the package receiving apparatus according to claim 10; and
a communication apparatus configured to receive package information wirelessly transmitted from the package receiving apparatus.

13. The package receiving system according to claim 12, wherein the communication apparatus is a wireless communication apparatus.

14. The package receiving system according to claim 12, further comprising a wireless communication apparatus configured to receive information transmitted from the communication apparatus.
